(19) United States
(12) Patent Application Publication
(10) Pub. No.: US 2021/0312009 A1
(43) Pub. Date: Oct. 7, 2021

(54) CONTENT AGGREGATION AND DATA STREAMING THROUGH UNIFIED APPLICATION FUNCTIONALITIES

(71) Applicant: Xchange Mall, Inc., Hawthorne, CA (US)

(72) Inventor: Osemwota Sota Omoigui, Hawthorne, CA (US)

(21) Appl. No.: 16/838,941

(22) Filed: Apr. 2, 2020

(51) Int. Cl. G06F 16/958; G06F 16/957; G06F 16/9532; G06F 16/28

(52) U.S. Cl. CPC G06F 16/972; G06F 16/9574; G06F 16/284; G06F 16/9532; G06F 16/9577

(57) ABSTRACT

There are provided systems and methods for content aggregation and data streaming through unified application functionalities. A super application may provide multiple application functionalities in a single convenient application or website that allows for users to navigate to particular channels that provide the application functionalities. The super application may aggregate data from different online resources, including other websites or databases. The data from these resources is then served to users through channel elements that allow for importing of data from these other resources into a channel interface for the channel. Users may interact with the data from the resources in each channel, where data is streamed in real-time to the users. Additionally, the users may navigate between channels to view different topics and retrieve aggregated data from different resources.

### TECHNICAL FIELD

The present application generally relates to unifying application functionality and online resource data in a single application and more specifically to a super application that streams real-time online data through application interface elements.

### BACKGROUND

Various types of applications may provide services to users, such as those involved with digital communications, content display and viewing, data posting and sharing, social networking, and other types of online functions and processes. Each online service provider may provide a separate service, which may be accessible through a website and/or dedicated application provided by the service provider. In order to utilize the services provided by each service provider, users are required to download and install many different applications and/or access a multitude of different websites. For example, an online platform accessible through a device application may be used to stream music or provide news, but not both. This negatively impacts device memory and performance, as well as causes increased bandwidth usage. Moreover, having multiple different applications or websites can become confusing to users and may cause users to dislike and disfavor interactions with certain service providers. This causes a decreased use in service provider services, which may cause some service providers to become obsolete. Content, as currently available, is partitioned with media and language walls between Internet content and multimedia content of movies and videos, television (TV), and radio. Users cannot seamlessly navigate between tasks such as shopping on the Internet, ordering groceries, and food delivery while watching movies all within a single space.

### BRIEF DESCRIPTION OF THE DRAWINGS

FIG. 1 is a block diagram of a networked system suitable for implementing the processes described herein, according to an embodiment;

FIG. 2 is an exemplary system environment having a service provider server that serves content through a super application, according to an embodiment;

FIG. 3A is an exemplary application interface for a website super application home screen, according to an embodiment;

FIG. 3B is an exemplary application interface for a website super application subject matter channel, according to an embodiment;

FIGS. 4A-B are different views of an exemplary application interface for a resident mobile super application home screen, according to an embodiment;

FIG. 4C is an exemplary application interface for a resident mobile super application subject matter channel, according to an embodiment;

FIG. 5 is a flowchart of an exemplary process for content aggregation and data streaming through unified application functionalities, according to an embodiment;

FIG. 6 is a block diagram of a computer system suitable for implementing one or more components in FIG. 1, according to an embodiment; and

FIG. 7A-7AAF are exemplary screenshots of a super application as presented on different device platforms, according to embodiments.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for content aggregation and data streaming through unified application functionalities. Systems suitable for practicing methods of the present disclosure are also provided.

An online service provider, such as a content aggregator for application data, may provide a dedicated application and a website that functions as a super application to provide a multitude of application functionalities through online resources in a single convenient device location. A super application such as this provides the functionalities of several applications through a single application that breaks down barriers and allows for unification of different processes and functionalities, with platform and user generated content in multiple formats, languages, and from multiple countries. This super application, and world-wide platform breaks down barriers, where a user can exchange goods, information, and services, perform content searching and be provided aggregated content in any language and from any region of the world. The super application further allows the user to play games, social network, date, and navigate between channel for chat, text, email, voice call, video call, video streaming, e-commerce, games, movies, videos, music, TV and radio, all within a single space. Users can generate their own multimedia content as well as search and access multimedia content in various categories, including news, videos, documentaries, movies, music, television, and radio stations in multiple languages and from multiple countries all over the world. This assists in minimizing memory and data consumption on a client device and provides a centralized application for the application functionalities. In this regard, the super application of the service provider may provide different data channels that each provide an application functionality and are related to a specific application subject matter or topic. Each channel may correspond to one or more interfaces that include data and processes associated with a topic, functionality, or other subject matter for the channel. The channels may be accessible through a home interface that includes channel icons or navigation links, as well as through a toolbar that allows navigation between channels from a specific channel or application interface. Thus, the channels for application functionalities may be accessible with minimized input and without launching a new application and executing processes with reduces usage of computing resources and processing power. The channels may correspond to topics and functionalities, such as news, games, community events, buddies or friends for social networking, dating, and messaging, events, business services, streaming media (e.g., audio, such as music, and/or video, such as television shows, movies, documentaries, television, and radio stations), shopping and purchasing, sale of items by other users, job posting and career choices, property sale and rental, travel, social/dating, community chat, events posting and viewing, application shopping, downloading, or accessing and the like. Such channels will be available in multiple languages, from multiple countries all over the world. The super application allows an infinite configuration of any number and variety of channels, content, processes and functionalities in various subjects, topics, formats, and languages from multiple countries all over the world.

In order to serve data through the different channels accessible through the super application, the online service provider may provide a data aggregation process, which utilizes culled resources to aggregate data from different online resources, such as websites, databases, and the like. The data aggregation process may receive a list of resources for aggregating data for particular channels, which may be culled by a system administrator and/or data aggregation process to prevent use of undesirable resources and/or provision of unwanted content. The list of available resources and/or the aggregated data may be stored to a relational database management system (RDBMS), searchable using a query language, such as standard query language (SQL) and the like. In other embodiments, the RDBMS may correspond to a NoSQL, or not-only-SQL, database that may be queried using a variety of data models. Information for each resource and their corresponding online data may therefore be determinable through a database query to the RDBMS based on search parameters and queries executed by users and/or the service provider for particular channels. The culled resources may be channel-specific in the RDBMS or may be otherwise tabled for searching, including by users, locations, topics, and other search fields. The RDBMS may store the resources as a uniform resource locator (URL) or a uniform resource identifier (URI) for the online resources address and online location so that data may be retrieved in real-time and streamed from the resource. Additionally, the RDBMS may also pull and store additional data for the resource where the additional data may be required or desirable and the data may become unavailable.

Thus, after determining the resources for each channel that serves data, processes, and other online content to users, the service provider may receive a channel data display request from a client device of a user. The request may be received when the user navigates to the channel, for example, from a home screen interface or toolbar based on a selection of a particular channel for display and interaction. The request for the channel data display may also be received after the user is already in the channel and may request to display different data to the user, such as a search query for particular data within a channel. Thus, the channel may provide a search field, drop down menus, or other selectable interface options that allow a user to execute a search. For example, a channel may include drop down menus to select country, language, location, radius of search, topics, and the like. The dedicated application and/or website incorporates a keyword search box powered by a custom search and analytic engine (e.g., Google®, Bing®, or other commercial or open source search engine), which enables search of all the application and/or website content. This application and/or website content may include textual, numerical, geospatial, structured, and unstructured content and data. Further, the custom search box or field using the engine enables users to run simple and complex queries for all the super application data, including all the websites and subdomains that are associated with the super application. A query for the RDBMS may then be generated based on the channel, and any search parameters entered by the user. In some embodiments, the super application and service provider may track user preferences and common search parameters, or previous menu selections, and may automatically enter such information with the search. For example, an account may be provided to a user by the service provider, which allows natural and international language to be converted to an SQL query or other data model query to search the RDBMS for the online resources associated with the channel data display request.

Based on the query, channel specific online resources and their particular data or navigation location may be determined from stored data in the RDBMS (e.g., the culled channel resource list of URLs or other navigation data). The service provider may pull and retrieve data from the online resource in real-time so that the data may be loaded to the channel of the super application. For example, the data may be retrieved from currently displayed or stored data for the online resource and/or the data from the online resource that is particular to that channel and/or search query. The data may correspond to webpage data, such as a news story, media content displayed on a webpage, or other information. Thus, the data may be taken from the corresponding URL or other network address. The data may also include dynamic data that is displayed on the online resource, such as messages, content that may be changed or dynamic (e.g., an animation), or the like. The data may also correspond to data within a database of the online resource, such as media content. In some embodiments where a marketplace, forum, social networking function, or other service is provided directly by the service provider, the data may be taken from data stored by the RDBMS or accessible to the system from another data storage platform. In such embodiments, the data may correspond to items for sale posted by other users or merchants, job postings, messages and social networking posts, and the like. In some embodiments, the data may include processes for execution, such as a Flash player application for playback of media or a video game. The data may include webpage displayed data and webpage processes, such as links or processing actions from a webpage.

Once the online resource's data is retrieved, the data may be streamed in real-time to the client device within the super application or based on the accessed website for the service provider. In order to stream the data in real-time within a dedicated application resident on the client device, application interface elements may be used to import the online content into the application for viewing and user interaction. The webpage interface elements may correspond to WebView, WKWebView, and/or UIWebView elements depending on the application and operating system of the client device. For example, an Android-based device may utilize WebView or WKWebView within the super application to output online content from an online resource. Conversely, UIWebView may be used for iOS-based devices executing that version of the super application. These interface elements allow real-time streaming and dynamic data display within an interface for the particular channel. The interface elements may correspond to a portion of the application that allows for output of the online content from the online resources.

Where the client device accesses a website version of the super application hosted by a website of the service provider, web pages for the channels may utilize embedded data from the online resources to output and stream the data in real-time to the client device when the client device accesses the web pages (and, in some embodiments, executes a search). An inline frame, or iframe, may be used to embed data from another webpage within a webpage of the service provider's website. For example, an iframe may be used to embed another HTML document within the HTML document for the present webpage. Thus, the iframe may provide dynamic real-time data from another online resource within the channel's webpage on the super application website of the service provider. One or more iframes may then output the streamed data from the other online resource based on the culled resources and/or search query for the channel.

Thus, through the use of the embedded interface elements, the super application does not require in-application functionality for different applications, or “mini-applications” within the super application. Instead, the super application may stream data directly into the application through the use of these elements. The super application may also include channels to post data for viewing by other users. In this regard, the super application may either link to external online resources, including databases, messaging platforms, voice over IP (VoIP) services, marketplaces for sale/rental of items or real estate, job and career services, media sharing services, social networking services, and/or microblogging services that allow users to post data, engage in voice and/or video communications, or perform other online interactions with other users. In some embodiments, the service provider may provide internal or associated platforms, databases, and services to allow for the aforementioned services through one or more channels of the super application, such as sale and marketplace channels, community channels, buddy or friends, channels, communication channels, and the like. The super application may include one or more operations for posting and messaging of data, including an operation to enter input, including text, images, video, and other content, and/or identify a user identifier for online or network communications. The operations may utilize one or more components of the client device, such as a camera, microphone, speaker, touch input, keyboard and mouse, or another component. During navigation to a channel of the super application, the super application may access and/or engage the components to allow for communications with other networked users through the super application.

Thus, the super application may provide a plurality of channels, interfaces, or other application features that allow for multiple application functionalities through streaming of online content using one or more interface elements. In this manner, a service provider may provide an application that reduces user and device friction from the execution of multiple different applications that each provide their own features. Moreover, the processing resources of a device and memory capacity may be reduced through singular application usage so that device resources may be conserved. This further helps reduce user input and time during navigation between applications to access different features. As such, the super application provides an improved computing system that increase processing speed and reduces resource usage.

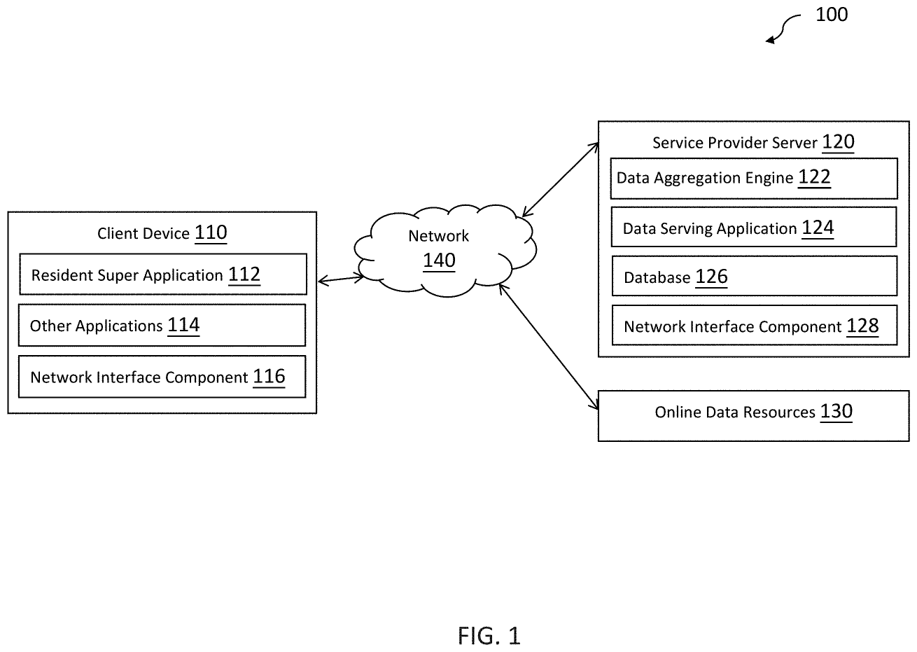

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a client device 110, a service provider server 120, and online data resources 130 in communication over a network 140. Client device 110 may be utilized to access the various features available for client device 110, which may include processes and/or applications associated with a super application that provides multiple application functionalities and data aggregated from service provider server 120. Service provider server 120 may provide a data aggregation service to enable output of online content through particular channels and interfaces provided by a super application resident on client device 110 and/or accessible through client device 110. Thus, client device 110 may be used to access resources provided through an RDBMS of service provider server 120.

Client device 110, service provider server 120, and online data resources 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client device 110 may be implemented as a communication device that may utilize appropriate hardware and software configured for wired and/or wireless communication with service provider server 120, and/or online data resources 130. For example, in one embodiment, client device 110 may be implemented as a personal computer (PC), telephonic device, a smart phone, laptop/tablet computer, other type of wearable computing device, and/or other types of computing devices capable of transmitting and/or receiving data. Client device 110 may correspond to a device of a user that may access a super application serviced by service provider server 120 in order to provide services, functionalities, and processes of the super application. Although only one communication device is shown, a plurality of communication devices may function similarly.

Client device 110 of FIG. 1 contains a resident super application 112, other applications 114, and a network interface component 116. Resident super application 112 and other applications 114 may correspond to executable processes, procedures, and/or applications with associated hardware. In other embodiments, client device 110 may include additional or different modules having specialized hardware and/or software as required.

Resident super application 112 may correspond to one or more application processes and features of client device 110 to provide multiple application functionalities within a single convenient application. In this regard, resident super application 112 may correspond to specialized hardware and/or software utilized by a user of client device 110 to access services provided by service provider server 120 for data aggregation and provision of online content through resident super application 112. As discussed herein, resident super application 112 may correspond to a general browser application configured to retrieve, present, and communicate information over the Internet (e.g., utilize resources on the World Wide Web) or a private network from service provider server 120, such as accessing a website that hosts the super application. However, in other embodiments, resident super application 112 may correspond to a dedicated application of online data resources 130 or other entity (e.g., a merchant), which may be configured to assist in processing transactions electronically.

Resident super application 112 may utilize one or more user interfaces, such as graphical user interfaces (GUIs) presented using an output display device of client device 110, to allow navigation to particular channels that provide content to users, allow users to engage in communications or data posting, or provide other application functionalities. In this regard, resident super application 112 may serve data aggregated by service provider server 120 through interface elements corresponding to WebView, WKWebView, or UIWebView through a dedicated application downloaded on client device 110 corresponding to resident super application 112. In other embodiments where resident super application 112 corresponds to a web browser, resident super application 112 may utilize iframes of embedded documents within an HTML document to serve data aggregated and culled by service provider server 120. Resident super application 112 may be used to access a home screen interface that enables a user to navigate to one or more channels. After navigation to the channels, resident super application 112 may provide data aggregated by service provider server 120 through the interface elements. Additionally, resident super application 112 may provide menu options and search fields to narrow down the content served in the channel based on search queries executed using a RDBMS of service provider server 120. Additionally, within each channel, resident super application 112 may further provide a toolbar that allows for navigation between channels.

In various embodiments, client device 110 includes other applications 114 as may be desired in particular embodiments to provide features to client device 110. Other applications 114 may also include email, texting, videos, voice and IM applications that allow a user to send and receive emails, calls, texts, and other notifications through network 140. In various embodiments, other applications 114 may include a browser application. However, client device 110 may access the aforementioned features through resident super application 112 so that the aforementioned application functionalities may be provided in a single application without the need for additional applications on client device 110. Other applications 114 may include security applications for implementing client-side security features, programmatic client applications for interfacing with appropriate application programming interfaces (APIs) over network 140, or other types of applications. Other applications 114 may include device interface applications and other display modules that may receive input from the user and/or output information to the user. For example, other applications 114 may contain software programs, executable by a processor, including a graphical user interface (GUI) configured to provide an interface to the user. Other applications 114 may therefore use devices of client device 110, such as display devices capable of displaying information to users and other output devices, including speakers.

Client device 110 includes a network interface component 116 adapted to communicate with service provider server 120 and/or online data resources 130. In various embodiments, network interface component 116 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, Bluetooth, Bluetooth Low Energy, LTE Direct, radio frequency, infrared, and near field communications.

Service provider server 120 may be implemented as a computing server that may utilize appropriate hardware and software configured for provision of aggregated and culled data from a RDBMS through one or more application interface elements for resident super application 112. Service provider server 120 may be used to provide content within application channels or interfaces. Thus, in certain embodiments, service provider server 120 may be used to host a website and/or provide application data for use by a resident dedicated application on client device 110. Although only one service provider server 120 is shown, a plurality of servers may function similarly and/or collectively.

Service provider server 120 of FIG. 1 contains a data aggregation engine 122, data serving application 124, a database 126, and a network interface component 128. Data aggregation engine 122 and data serving application 124 may correspond to executable processes, procedures, and/or applications with associated hardware. In other embodiments, service provider server 120 may include additional or different modules having specialized hardware and/or software as required.

Data aggregation engine 122 may correspond to one or more processes and/or hardware of service provider server 120 to provide data aggregation services for website and dedicated resident super applications that incorporate several application functionalities through a single application or portal. In this regard, data aggregation engine 122 may correspond to specialized hardware and/or software of service provider server 120 to determine a culled resource list stored to database 126 that includes URLs, URIs, or other network addresses or device/server/application identifiers of external resources used to stream data into channel interface elements for subject matter channels of a super application executed by client device 110 (e.g., resident super application 112). Data aggregation engine 122 may further include data resources, lists, tables, and other data structures necessary to determine internal data, processes, and information that may be used to serve data through one or more channels and channel interface elements of the super application. Data aggregation engine 122 may receive the culled resources list, table, identifiers, and/or other information from an administrator of service provider server 120. However, in some embodiments, data aggregation engine 122 may determine the culled resource list from other online information, system processes, and the like based on risk or business rules, resource selection parameters, previous user histories, visited websites, high traffic websites, and the like.

Data serving application 124 may correspond to one or more processes and/or hardware of service provider server 120 to provide and/or stream data within a channel based on the channel's subject matter and culled resource information provided by data aggregation engine 122. In this regard, data serving application 124 may correspond to specialized hardware and/or software of service provider server 120 to detect a navigation by a device, such as client device 110, to a home screen interface of a website or resident device super application (e.g., resident super application 112), from the home screen interface to a subject matter and/or application functionality channel, and/or between those channels of the super application. The home screen interface may include a plurality of application functionalities such that the super application provides multiple different application subject matters and functionalities through one convenient application. Thus, the home screen interface allows access and navigation to different types of applications, including communication, social networking, marketplace, news, media sharing and viewing, and the like.

After navigation to a particular subject matter that serves topical and/or application functionality content and processes by client device 110, data serving application 124 may determine the resource particular to that channel for serving data from online data resources 130. For example, the culled resources for a channel may correspond to a subset of online data resources 130 culled for that channel that are designated by culled resource information established by data aggregation engine 122. Data serving application 124 may generate a query for the resources from database 126, for example, by using a database query (e.g., SQL query or other type of data query for another database structure, such as a NoSQL-type RDBMS). The query may include all data resources for the channel or a subset of the data resources based on a query by a user in the super application's channel. The query may also be generated based on parameters for the user or device that causes a query for the subset of the data resources (e.g. a device location, IP address, timestamp of data request and/or channel access, past queries and/or visited websites/resources, and the like). Thus, the query may be generated for the channel by search terms entered by a user or automatically entered to the query based on the parameters.

Once the query has been generated, data serving application 124 may execute a search using a search protocol for the RDBMS for database 126 to determine the network addresses and/or identifiers used for retrieval of channel data and streaming of the channel data into interface elements of the channel. Using the search results and corresponding online resources culled for the channel, data serving application 124 may retrieve data from the online resources. Data serving application 124 may serve the data into channel interface elements for the channel by streaming real-time live data from the online resource as the data is available (e.g., posted, shared, or otherwise accessible from the resource). When the data is streamed into a resident dedicated super application stored locally on client device 110, the data may appear through a WebView, WKWebView, or UIWebView interface element or field that allows for population of online and/or website data from online data resources 130 within an interface of the super application. However, where the super application is accessed through a website, inline frames or iframes may be used to stream the data within the channel.

As the data is streamed in the channel, the data may be updated and/or refreshed based on device requests and/or as the data is updated with the online resource. For example, the online resource may change the data or client device 110 may request refreshment of the data. Data serving application 124 may also receive selection of the data and navigation to the data from an interface element of the channel, which may cause data serving application 124 to retrieve additional data and/or stream the data into another interface element (e.g., a window, screen, or interface that increase the size of the interface element and allows interaction with the data, such as streaming of media, playing a game, or responding to a communication). Data serving application 124 further provides features to service provider server 120 to serve the aforementioned data through device applications, including dedicated applications and/or web browsers. For example, data serving application 124 may include security applications for implementing server-side security features for data streaming and distribution, programmatic client applications for interfacing with appropriate application programming interfaces (APIs) over network 140, or other types of applications. Data serving application 124 may include server interface applications for an online server platform that output data to one or more devices. For example, data serving application 124 may contain software programs, executable by a processor, including a graphical user interface (GUI) configured to provide interface data for display on devices.

Service provider server 120 may further include database 126 stored in a transitory and/or non-transitory memory of service provider server 120, which may store various applications and data and be utilized during execution of various processes of service provider server 120. Database 126 may include, for example, identifiers such as operating system registry entries, cookies associated with data aggregation engine 122 and/or data serving application 124, identifiers associated with hardware of service provider server 120, or other appropriate identifiers, such as identifiers used for user, device, and/or account authentication. In various embodiments, database 126 may correspond to a relational database management system (RDBMS) that may be queried for culled data aggregation lists and other information of online resources used for output of data within an application channel or interface. In this regard, database 126 may include information, tables, key-value databases, and other data models that store structured, semi-structured, and other data and documents. In certain embodiments, database 126 may be queries using a query language, such as standard query language (SQL) or other data storage model and query language.

Service provider server 120 includes at least one network interface component 128 adapted to communicate with client device 110 and/or online data resources 130 over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Online data resources 130 may correspond to various types of online websites, databases, and other web or network data resources that may provide content to service provider server 120. In this regard, online data resources, may correspond to media content and streaming websites, such as those providing audio, visual, and audiovisual content to networked devices and servers. Such content streaming websites and resources may include news, movies, videos and user generated content, music, radio, television, and other resources that may provide content from anywhere in the world in different languages and formats. Online data resources 130 may also correspond to external merchant and user marketplaces where users may buy, sell, and/or trade items and services. Online data resources 130 may also allow for other types of purchases, sales, rentals, and trades involved with real property, including leasing and rental associated with travel and/or home property. Online data resources 130 may also provide for travel and vacation purchases, rentals, and other commerce. Online data resources 130 may include other online platforms to post jobs and/or requests for work or employment, as well as engage in other employment services and communications. Online data resources 130 may include online resources involved in scheduling events, including venue scheduling, ticket purchases, calendaring, and the like. Online data resources 130 may include platforms, servers, and applications to access and play video games, including necessary software for delivery to client device 110 for rendering video game interface data. In some embodiments, online data resources 130 may include forum and posting websites or portals, social networking platforms, microblogging platforms, and the like, which may allow users to post information, messages, media, and otherwise share data. In some embodiments, online data resources 130 may also include internal resources of service provider server 120 for the aforementioned services, which may be provided directly by service provider server 120 without requiring streaming of data and content from external web sites and platforms.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

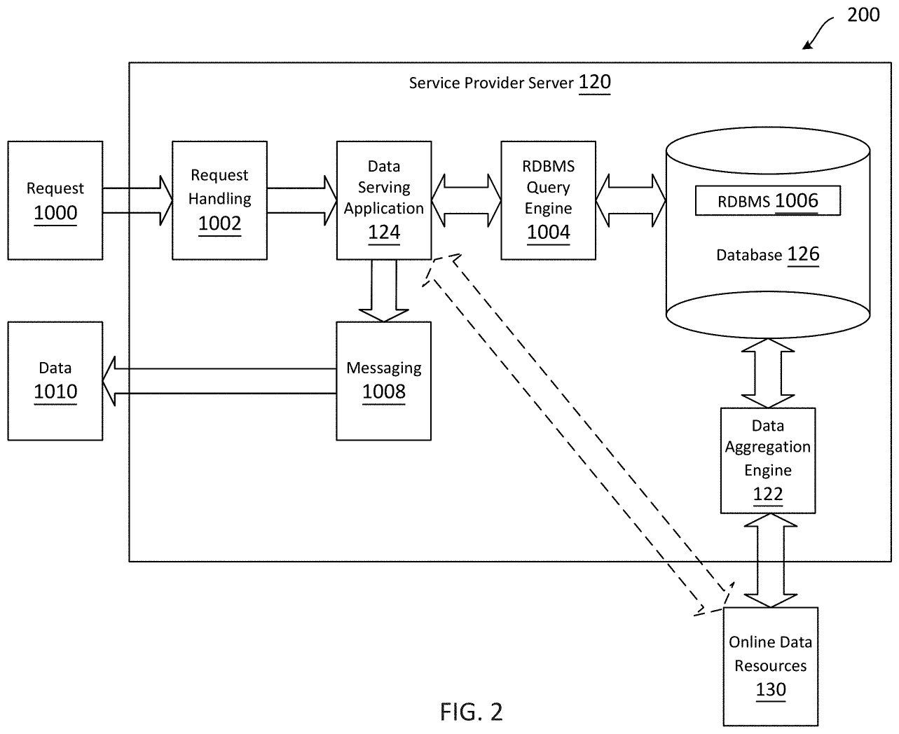

FIG. 2 is an exemplary system environment having a service provider server that serves content through a super application, according to an embodiment. Environment 200 of FIG. 2 includes service provider server 120 and online data resources 130 having the functionalities and features described in reference to system 100 of FIG. 1. In this regard, service provider server 120 similarly includes data aggregation engine 122, data serving application 124, and database 126 discussed in reference to system 100 of FIG. 1.

Service provider server 120 may provide resources for a super application resident on a device, such as a mobile device, tablet computer, personal computer, or other client device, or accessible from a website provided by service provider server 120. In this regard, the super application may provide multiple subject matter and/or functionality channels accessible through a home screen interface and/or toolbar in one or more application interfaces that allows navigation to particular channels. When navigating to a channel and/or interacting in a channel, service provider server 120 may receive a request 1000 from an external device, such as the aforementioned client device. Request 1000 may correspond to a navigation to a channel of the super application or may correspond to a query within a channel through one or more inputs, menu selections, and the like that specific search parameters, such as location, time, language, topic, and the like. Request 1000 may be received through a device super application residing on a device or may be received from a website hosted by service provider server 120.

Request 1000 may then be handled by request handling 1002, which may correspond to one or more operations, routines, subroutines, and the like used to handle data requests and route the data requests to the handling applications of service provider server 120. Request handling 1002 may therefore transmit request 1000 to data serving application 124 in order to have request 1000 processed and data from database 126 served to the external client device. Prior to and/or while serving data to one or more client devices, service provider server 120 may determine data for database 126 using data aggregation engine 122, which may store tables and other data for URLs, network addresses, identifiers, and/or other identification information using for identification of internal and external online data resources 130, communication with those resources, and data retrieval and streaming into a super application. The identification information may be received from a system administrator or through determination using parameters, preferences, and other selection criteria for service provider server 120 and/or a client device or user. Data aggregation engine 122 may determine the identification information from online data resources 130, which may be stored in database 126 and accessible through RDBMS overlying the data in database 126, which allows querying for and identifying particular portions of the data for super application channels and channel queries. Data aggregation engine 122 may update the identification information after establishment based on changes to online data resources 130.

Thus, data serving application 124 may issue one or more application programming interface (API) calls for data from database 126 to RDBMS query engine 1004, which may query database 126 through RDBMS 1006 that overlies and organizes the data structures of database 126 associated with data aggregated by data aggregation engine 122. Data serving application 124 may include an API of a software application that integrates with an API of RDBMS query engine 1004 to send and receive API calls associated with a query for data and return data from database 126. The API calls correspond to operations that data serving application 124 and RDBMS query engine 1004 may utilize to perform operations associated with querying database 126 and retrieving data from database 126. RDBMS query engine 1004 may receive the query, which may be converted to SQL or other query language, including natural and international language, hypertext SQL (HTSQL), Java persistence SQL, and other query languages for searching a NoSQL database or other database. Once the query is converted to a query language handled by RDBMS query engine 1004, RDBMS query engine 1004 may utilize the query with RDBMS 1006 to retrieve information stored by database 126 and provide the information of the corresponding channel's culled resources to data serving application 124.

Data serving application 124 may then utilize the returned identification information to retrieve data from online data resources 130 and stream the data to the client device through the super application. Data serving application 124 may interface with the online resources to retrieve the data. In other embodiments, data serving application 124 may return the identification information to the super application so that the super application may utilize the network addresses, identifiers, and other identification information to retrieve the data directly and stream the data into the super application's interfaces. Data serving application 124 may then be used to output the data in the super application used by the client device submitting request 1000. Data serving application 124 may therefore include an API that interfaces with one or more APIs of messaging 1008, where messaging 1008 corresponds to communication operations and/or applications used to communicate with client devices and other requesters of data within the super application provided by service provider server 120. Messaging 1008 may be used to generate specific messages and other data transmissions used to stream data into the super application and/or provide the super application with the identification information necessary to retrieve and stream the data into the super application. Thus, messaging 1008 may generate data 1010, which may be output to the client device by service provider server 120. Data 1010 may then be processed by the client device for output of the particular online content from online data resources. Data 1010 may be formatted for WebView, WKWebView, and/or UIWebView for resident dedicated super applications on client devices, or for HTML and iframes for a website super application.

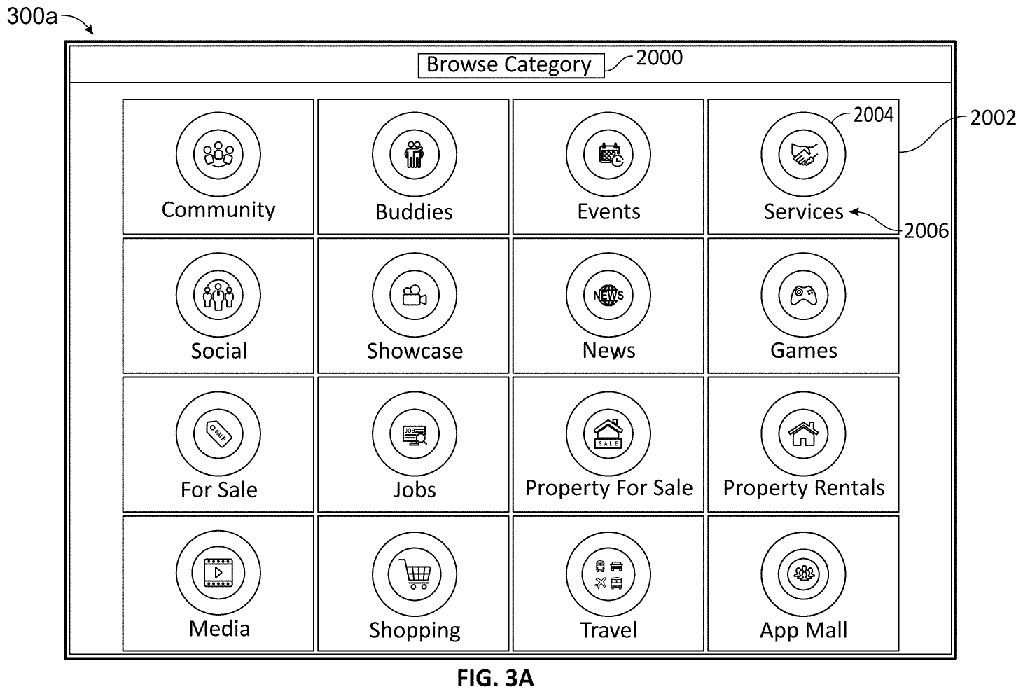

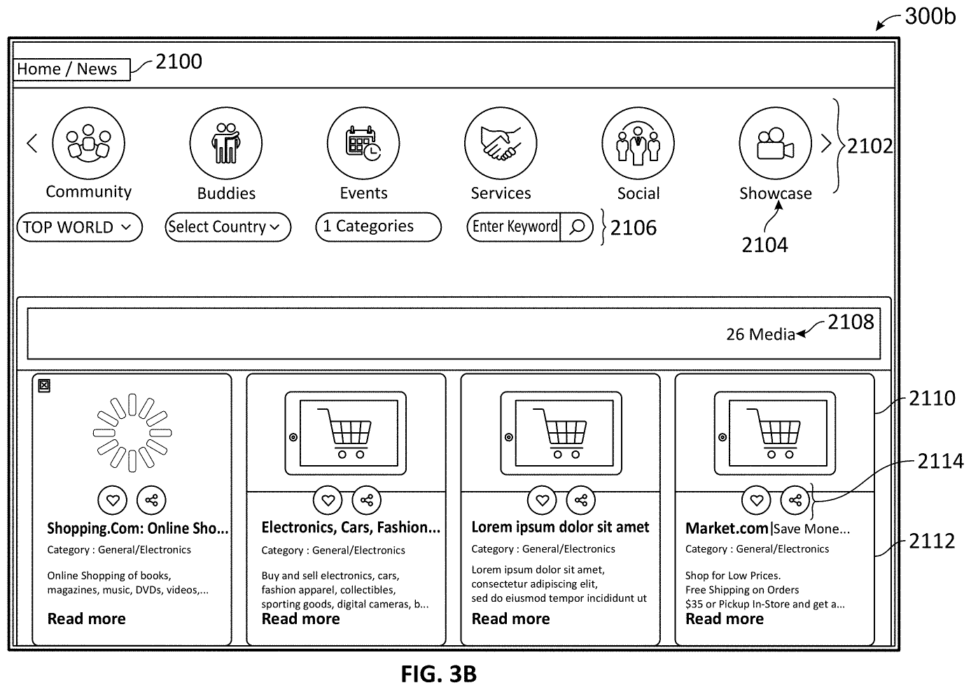

FIG. 3A is an exemplary application interface for a website super application home screen, according to an embodiment. In environment 300a of FIG. 3A, an interface may be displayed by a client device, such as client device 110 discussed in reference to system 100 of FIG. 1. The interface may be provided by a device application, such as a web browser that may be used to access a website super application within the web browser.

Interface 2000 may be used to select one or more channels of a website super application accessed by a user's device, such as a channel having a specific topic or information of relevance to a user. In this regard, each of the channels may correspond to a functionality of the super application, which serves data that may be aggregated and culled from multiple online resources, such as other websites, databases, or resource providers. Interface 2000 allows a user to navigate between channels from an initial homepage, which may be accessed through a uniform resource locator (URL) or other website identifier or address.

Once a device application is navigated to interface 2000, the different channels may be viewed with information for the channels so that a user may make a choice between the different channels. These channel functionalities or topics may correspond to a community channel, a news channel, a games channel, and the like as shown in environment 300a. For example, channel 2002 may correspond to “services” provided by the super channel. The services channel may provide a channel where users may post and view business services, such as a business and company name, address, location, website, and one or more services provided by the business. Additionally, the services channel may provide messaging and communication functionalities for the posting and viewing of business services. These may correspond to functionalities provided by the super application's channel, such as VoIP calls, video calls, messaging, email, and other services. Similarly, a different channel may also provide services offered by the super application. Channel 2002 may also be identified by a channel image 2004 and a channel descriptor 2006. Channel image 2004 and channel descriptor 2006 may include information that allows the user to view the channels topic. This allows navigation between different content, channels, and services in few mouse clicks or touch navigations, application executions, search processes, or other computing event.

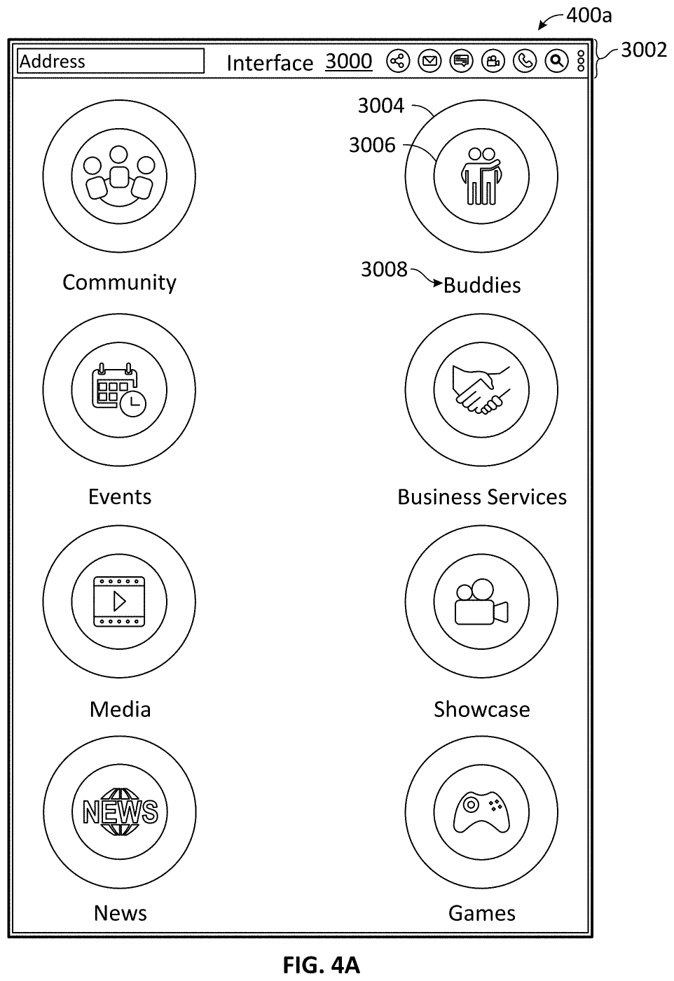

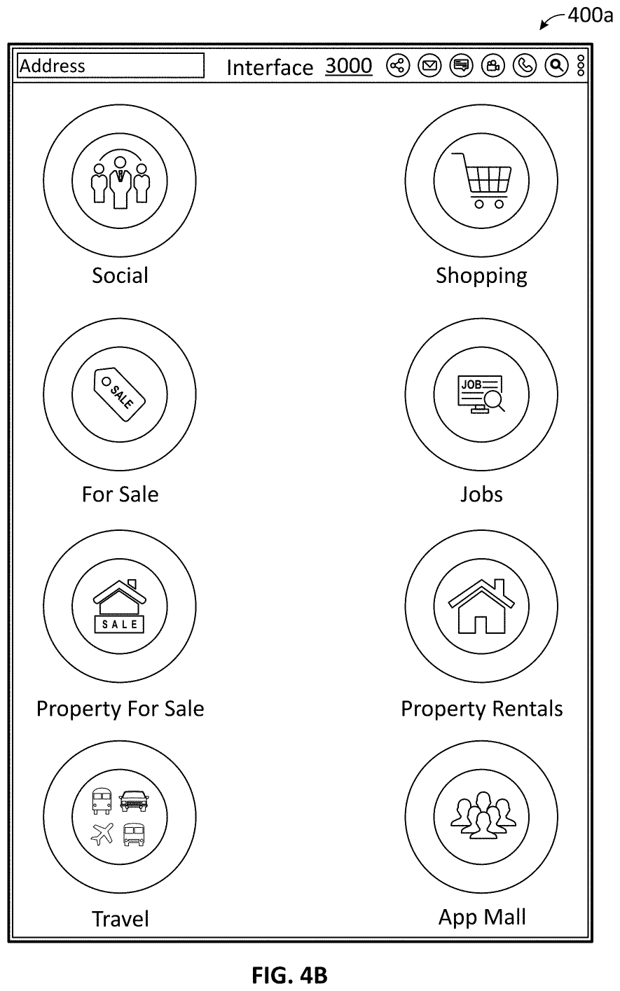

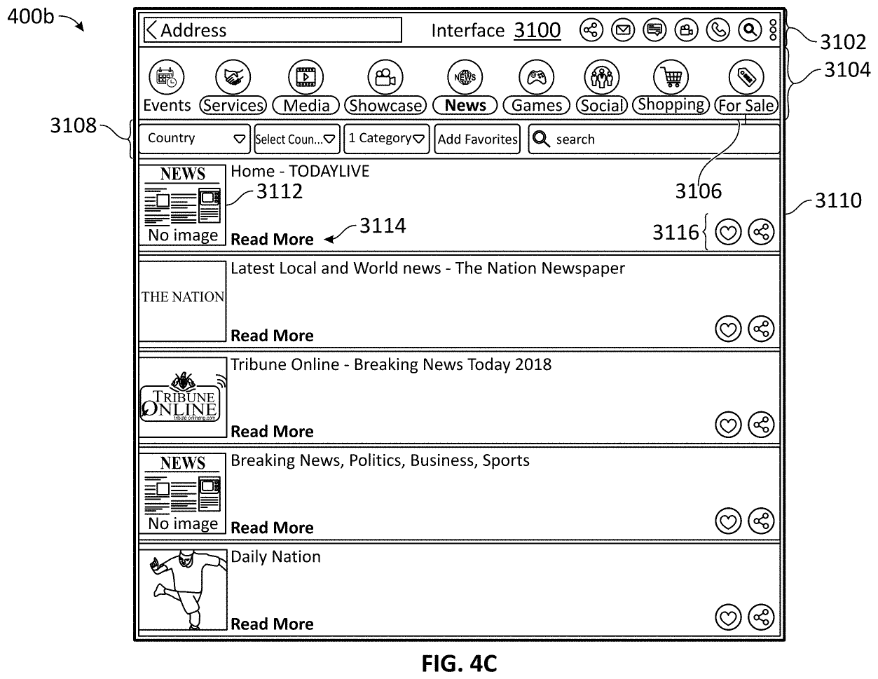

However, other channels may provide different data. For example, a “news” channel may aggregate news data information and stories from multiple online resources, in multiple formats including news sites, video streaming, TV, radio, which may be culled by one or more processes for the super application. Additionally, the aggregated data may be searchable by the user through one or more search menus that allow searching by location, category, keyword, favorite designation, or other search functionality. A user may designate a specific website or other online resource as a favorite through navigating to the online resource, entering an identifier (e.g., a URL) of the online resource, and/or selecting a favorite designation on a viewed resource. This may be saved for the particular user or account so that when the user visits the website (or loads the dedicated application described in further detail in FIGS. 4A and 4B), the favorites may be loaded. Other types of channels may provide other services and/or content. For example, interface 2000 in environment 300a includes a “community” channel, a “buddies” channel, an “events” channel, the aforementioned “services” channel, a “social” channel, a “showcase” channel, the aforementioned “news” channel, a “games” channel, a “for sale” channel, a “jobs” channel, a “property for sale” channel, a “property rentals” channel, a “media” channel, a “shopping” channel, a “travel” channel, and an “app mall” channel. These channels may similar provide functionalities for resource aggregating, culling, messaging, searching, favoriting or “liking,” and other of these features.

Additionally, the other channels may provide different functionalities. For example, the community channel may allow for interaction with other users, including providing chat rooms for video, audio, instant messaging, or other communication medium. These may be organized into topics, as well as private or public chats, and may include administrators that may manage particular chats. Private chats may require invitation by these administrators or other users. User may view contact lists and history screens, as well as perform searching using search tools. The buddies channel may provide for social networking interactions, including user profiles, social and services pages, and connection with other users. These connections may include adding the other user as a “buddy” and/or following a social networking feed for the other user. Requests to add a buddy or follow may require approval and may allow for users to limit connections or otherwise cull their feed from other users. The feed may include posts, images, videos, or other information provided by a buddy on a social networking channel. Additionally, a symbol, such as a hashtag or “@” symbol may be used to direct content to a particular user, group, or other entity, as well as hyperlink to search results or names.

The events channel may allow for users to enter information for private or public events. These events may further be limited to particular users, locations, or another filter, and may be searchable. The media channel may include a media hub or other media center where images, videos, or other content may be added, searched, viewed, or otherwise consumed. A user may also designate favorites and/or select searchable options from the media. The showcase channel may allow for viewing or consuming of live stream video, live stream audio, or another online channel that may have live, upcoming, or recordable events or media that may be viewed. Videos may be presented with a date, time of presentation, number of views, and/or cost (or free if the media doesn't not require a payment). Users may comment on videos and/or provide other feedback, as well as search for particular content. The games channel may allow for users to access or link to online gaming platforms that allow for instant gaming. This may be free or may require access to an account and/or payment for playing of a live game. These games may be played directly within the super application and do not require downloading of another application, such as a Java game or a HTML5.

Further, the social channel may provide a comprehensive dating space where users can post and search for different users from different types of dating. This further provides for processes to message and video chat their match or otherwise view images, video, profiles, or other information of their matching user. The shopping channel allows for users to search for posted items by merchants or items available from an online marketplace, as well as search within these posted items or online marketplace. Similarly, the for-sale channel allows for users to post items and view items for sale from other listings and users of the super application. This allows for users to shop between different users and merchants with much less navigations and through the same application. The jobs channel provides a place where users can post job listings and view other posted job listings, which allows for messaging or chatting between employers and employees.

The super application may also include channels associated with property, such as a property for-sale channel and a property rental channel. This allows for posting of rental or purchasable properties, as well as viewing and searching these property listings and posts in a fast and efficient manner. The travel channel may allow for users to open and view a travel hub or center within the super application, which allows users to view and search travel offers, listings, media, resources, or other travel information provided by one or more online resources. Additionally, a user may add their favorite travel resources and search for other resources. Finally, the super application may further include an application store or “app mall” channel. The app mall allows a user to view all online resources (e.g., through URLs, online app marketplaces, and the like) where users may download (e.g., either free or paid) applications that may work on Android, iOS, through a website or web browser, or other platform. This allows for users to directly link to and download applications from a publisher's online platform (e.g., a website, application store, etc.). The super application allows any number, variety and configuration of channels, content, processes and functionalities in various subjects, topics, formats, and languages from multiple countries.

FIG. 3B is an exemplary application interface for a website super application subject matter channel, according to an embodiment. In environment 300b of FIG. 3B, an interface may be displayed by a client device, such as client device 110 discussed in reference to system 100 of FIG. 1. The interface may be provided by a device application, such as a web browser that may be used to access a website super application within the web browser.

After selecting one of the channels shown in environment 300a of FIG. 3A, a device's application (e.g., web browser) may be navigated to a particular channel. As shown in environment 300b, channel interface 2100 is a “news” channel that includes data of aggregated news stories from one or more online resources, such as other websites providing news stories. Channel interface 2100 also allows for navigation between channels without having to revisit a home screen interface. In order to do this, channel interface 2100 includes a channel toolbar 2102, which includes channel icon 2104 that allows for navigation to a different channel. Channel toolbar 2102 may be dynamic such that channel icon 2104 or other icons in channel toolbar 2102 may be changed depending on the channel functionalities.

Additionally, a user may utilize data within channel interface 2100 to view additional information, such as the news stories displayed in channel interface 2100. First, news stories may be searched and/or provided within channel interface 2100 based on a search bar 2106. Search bar 2106 may include one or more search fields and/or selectable menu options to more specifically display news stories or other data. In response to a search query, media items 2108 may be returned and displayed in channel interface 2100. Media items 2108 may be displayed through iframes within a frame in the HTML document for the super application website. The data may be retrieved by the super application through retrieving the data from another website or database. Thus, a news story 2110 from another website may be aggregated and displayed in channel interface 2100. A user may view information 2112 for news story 2110 that provides more detailed information for news story 2110. Further a user may utilize options 2114 to respond to news story 2110, such as approving or liking the story, downvoting or disapproving of the story, and/or sharing the story with other users.

FIGS. 4A-B are an exemplary application interface for a resident mobile super application home screen, according to an embodiment. In environment 400a of FIGS. 4A-B, an interface may be displayed by a client device, such as client device 110 discussed in reference to system 100 of FIG. 1. The interface may be provided by a device application, such as a resident that may be used to access processes provided by super application on the device.

Similar to environment 300a, interface 3000 may also be used to select one or more channels of a super application, such as a channel having a specific topic or information of relevance to a user. For example, interface 3000 in environment 400a similarly includes a “community” channel, a “buddies” channel, an “events” channel, a “services” channel, a “social” channel, a “showcase” channel, a “news” channel, a “games” channel, a “for sale” channel, a “jobs” channel, a “property for sale” channel, a “property rentals” channel, a “media” channel, a “shopping” channel, a “travel” channel, and an “app mall” channel. Each of these channels is discussed in reference to interface 2000 of environment 300a in FIG. 3A. However, interface 3000 may be displayed by a resident super application on a user device, such as a mobile application on a mobile smart phone or tablet computer. In this regard, each of the channels may correspond to a functionality of the super application, which serves data that may be aggregated and culled from multiple online resources, such as other websites, databases, or resource providers. Interface 3000 allows a user to navigate between channels from an initial homepage, where interface 3000 may be displayed in response to accessing or opening the resident application and navigating through user input (e.g., touch inputs, mouse/keyboard, or the like) to the home screen or page.

Once a resident application is opened to interface 3000, multiple channels may be scrolled through and selected for interaction. Only a partial number of the available channels may be initially viewable through interface 3000, which may then be scrollable to view and navigate to particular channels corresponding to functionalities and/or topics available through the super application. Each of the channels in environment 400a may be similar to the ones shown in environment 300a that are offered by the super application. Interface 3000 may further include application options 3002, which allow for viewing and/or navigating to options, preferences, services, and/or profiles that can be established with the super application or used with the super application (e.g., a user account, name, and/or profile that can be established for the user with the super application). Additionally, these channels in interface 3000 may also be viewable by a channel icon 3004, which can be selected to navigate to the channel (e.g., a buddies channel for adding people to a friend list and/or interacting with the contacts and friends). Channel icon includes a channel image 3006 and a channel descriptor 3008 that further inform a user of the channel topic and identify the channel. Selection of one of the channel icons results in navigation to the interface shown in FIG. 4C.

FIG. 4C is an exemplary application interface for a resident mobile super application subject matter channel, according to an embodiment. In environment 400b of FIG. 4C, an interface may be displayed by a client device, such as client device 110 discussed in reference to system 100 of FIG. 1. The interface may be provided by a device application, such as a resident that may be used to access processes provided by super application on the device.

After selecting one of the channels shown in environment 400a of FIGS. 4A-B, a device's resident application downloaded and installed on the device may be navigated to a particular channel within an interface (e.g., graphical user interface of the device). As shown in environment 400b, channel interface 3100 is a “news” channel that includes data of aggregated news stories from one or more online resources, such as other websites providing news stories. Interface 3100 may further include similar toolbars to that of the website super application and may further display the same or similar toolbars that are shown in the home screen of the resident super application on a user's device. In this regard, options 3102 may be display in a top portion of interface 3100 so that a user may navigate to particular options, preferences, accounts, and/or profiles. Further, within a specific channel, a channel toolbar 3104 may be used to navigate to another channel, such as a “for sale” channel through selection of a channel icon 3106. Channel toolbar 3104 may be dynamic such that channel icon 3106 or other icons in channel toolbar 3104 may be changed depending on the channel functionalities.

Within the channel displayed in channel interface 3100, information may be viewed by a user, which corresponds to the topic of the channel as well as any searches or other entered data within the channel. In this regard, a “news” channel within channel interface 3100 may display news stories to the user. A search bar 3108 may be used to search for news stories or otherwise refine and narrow aggregated news stories from one or more online resources, databases, or websites. As shown in channel interface 3100, multiple news stories are displayed for a search, which includes a news story 3110. A user may view a preview 3112 of news story 3110 through the icon for preview 3112, which may be generated and/or displayed from the data for news story 3110. News story 3110 may be displayed through channel interface 3100 by importing data from another resource into the super application's interface through Web View, WKWebView, and/or UIWebView. Thus, data may be displayed from other sources in the application through interface elements or fields that allow for importing of data. Selection of story details 3114 may allow for navigating to and displaying further data for news story 3110 within the super application's interface using Web View, WKWebView, and/or UIWebView.

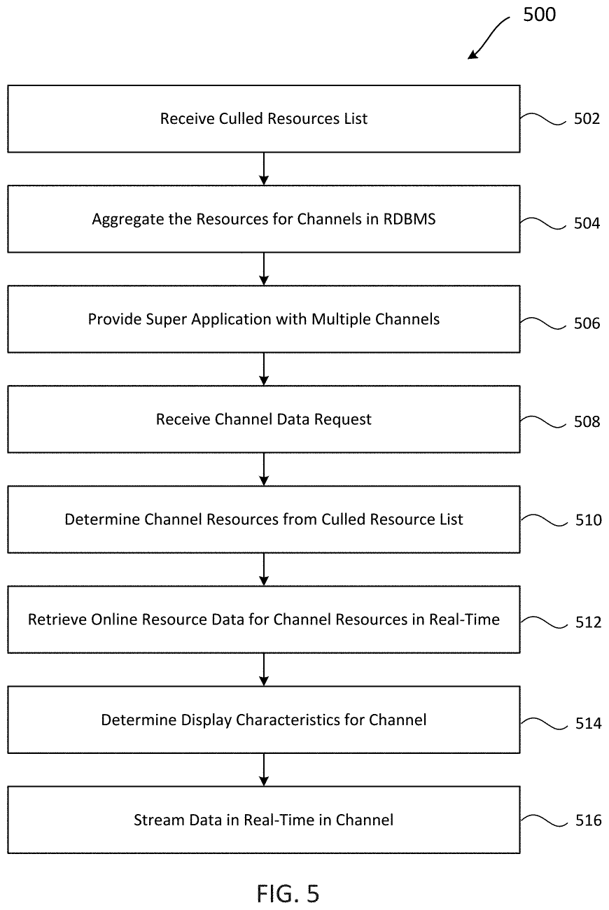

FIG. 5 is a flowchart 500 of an exemplary process for automatic data pull requests using a secure communication link between online resources, according to an embodiment. Note that one or more steps, processes, and methods described herein may be omitted, performed in a different sequence, or combined as desired or appropriate.

At step 502 of flowchart 500, a culled resources list is received by a service provider or other entity providing a super application on a client device or accessible through a browser application of the client device (e.g., on a website). The culled resources list may be received from a system administrator that designates the culled resources from available online resources internal and/or external to the service provider, which may be updated periodically. In some embodiments, the list may be generated and/or updated based on resource designation parameters of the service provider. The culled resources list may include URLs, URIs, identifiers, network addresses, or other identification information of a resource and that resource's corresponding content and/or designation (e.g., what channel(s) the resource is for, the location, recency of update and/or refreshment, and the like). However, in some embodiments, information about the resource may be retrieved from the resource (e.g., displayed data on the resource) or determined using the network address.

Thereafter, the resources are aggregated for the channels and the channels sub-matters and topics in an RDBMS, at step 504. The resources are aggregated for searching and querying when users navigate to channels for the super application and/or perform searches or data requests within the channels. Utilizing data accessible through the RDBMS, a super application with multiple channels is provided, at step 506. The super application provides multiple application functionalities through a single convenient application, which reduces computing resources required by storing and running multiple applications on a device or accessing multiple websites through a browser of the device. This allows for navigation between channels that provide subject matter and application functionalities without running multiple different applications. Moreover, this reduces friction by providing a plurality of functionalities through knowledge of one application's use, features, and navigations.

At step 508, a channel data request is received for a channel of the super application, for example, based on navigation to a subject matter channel of the super application from a home screen or toolbar pane, a query within a channel, and/or other action within the super application that requests application data output and functionality associated with an application channel. Thus, the channel data request may include data queries for information from a database of the service provider and/or data aggregation engine for the super application. The channel data request may therefore request a subset of specific application data and functionality incorporated within the multiple processes of the super application. Channel resources from the culled resource list are determined, at step 510. Channel resources may be determined by making a database query call through a query engine or system of the database management system, such as a NoSQL or other RDBMS system that allows for database querying. The channel resources may correspond to all resources culled for the channel in the database or may correspond to a subset based on the query, user/device parameters (e.g., location, time, language, and the like), or other query parameter. The channel resources determined at step 510 may correspond to URLs, identifiers, or other information allowing for identification of the online resource location and retrieval of data necessary to stream information into the channel of the super application.

Online resource data for the channel resources is then retrieved in real-time, at step 512, by one or more of the service provider's servers for the super application and/or the client device executing the super application. At step 514, display characteristics for the channel are determined, such as a process to display data within the channel (e.g., iframes, WebView, WKWebView, and/or UIWebView). Additionally, the display characteristics may include search features or preferences by a user to display the data in a certain order or format within the channel. The data may then be streamed into the channel in real-time, at step 516, for example, through iframes in HTML code for a website hosting a super application or WebView, WKWebView, and/or UIWebView for resident dedicated super application. This allows a user to view aggregated data from multiple online resources within a super application interface, thereby providing a more condensed data feed of information to a user.

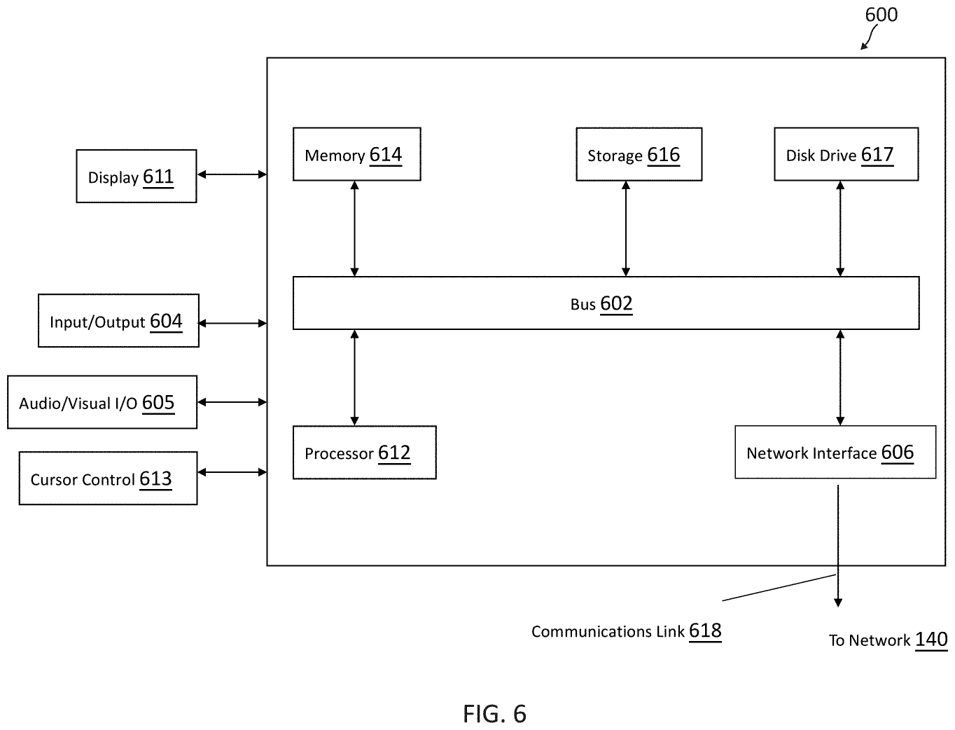

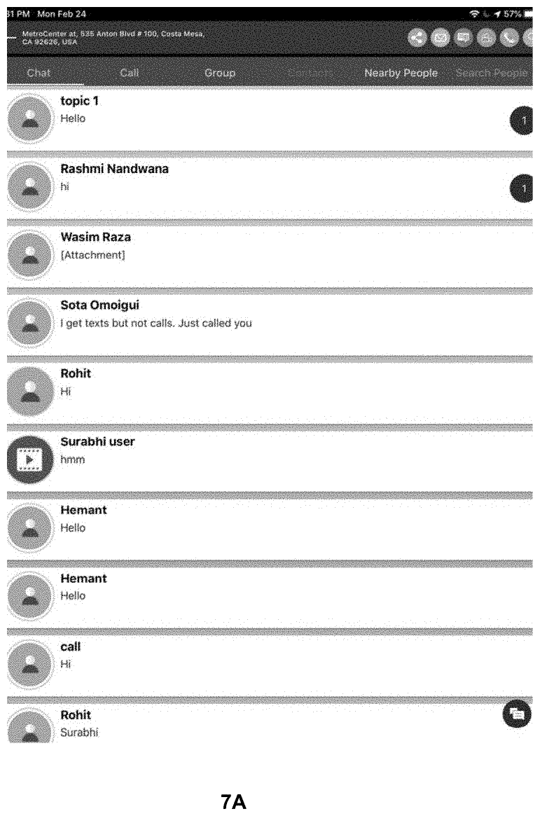

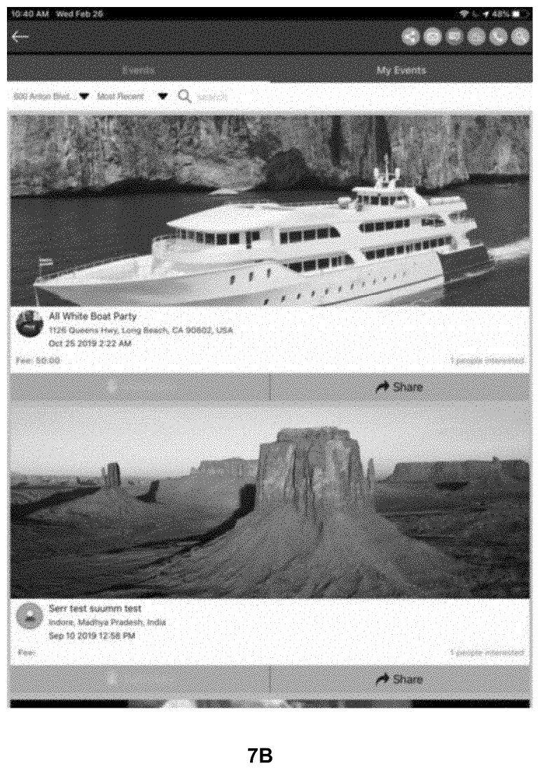

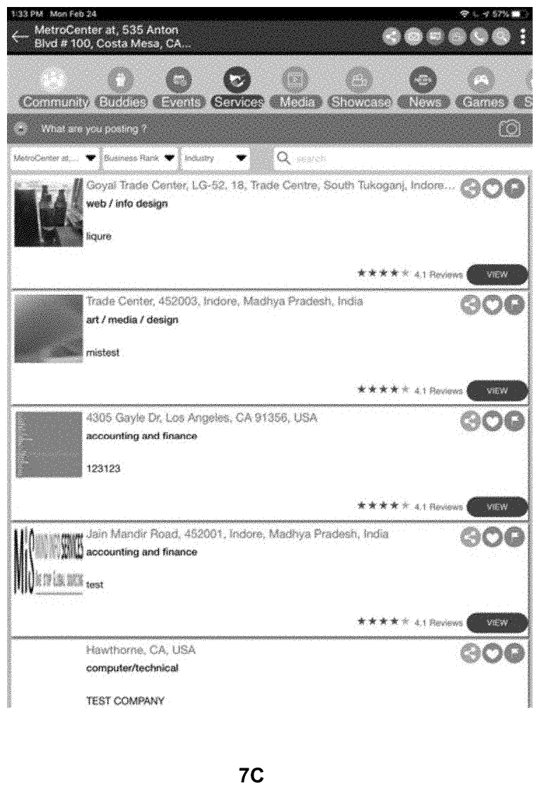

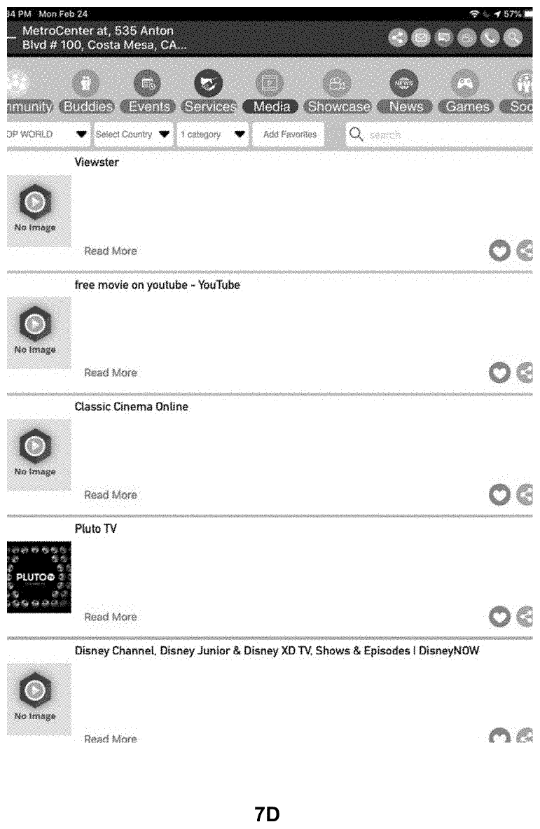

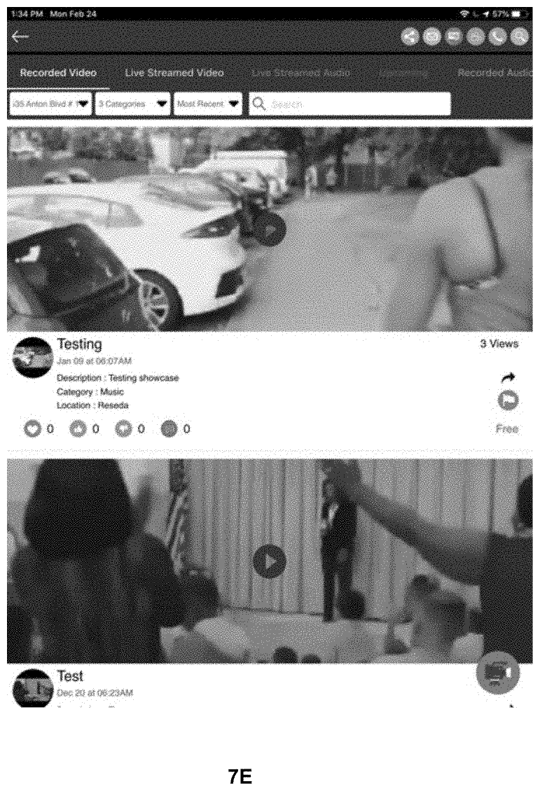

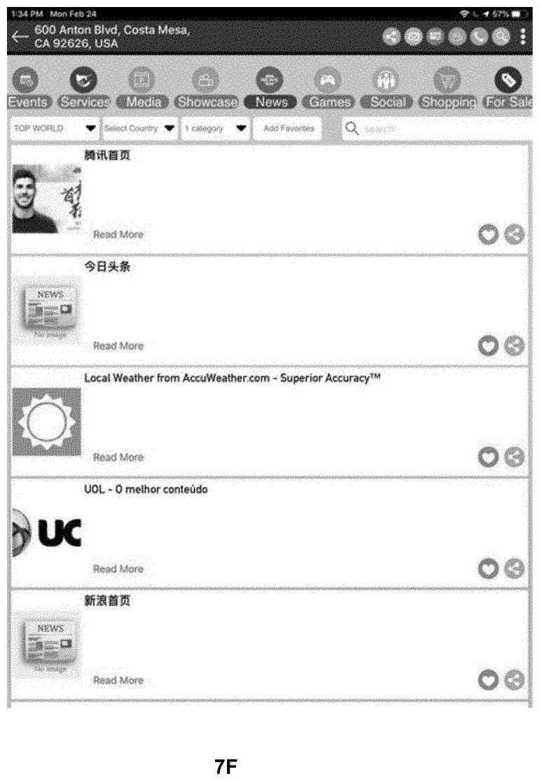

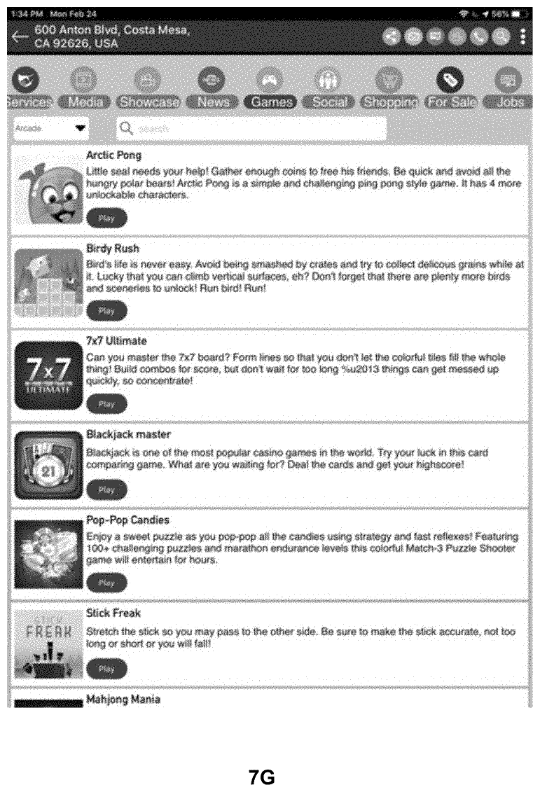

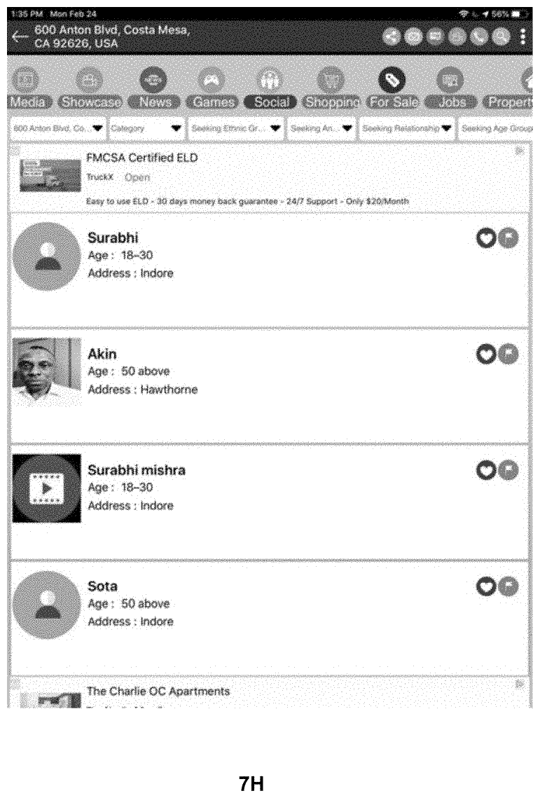

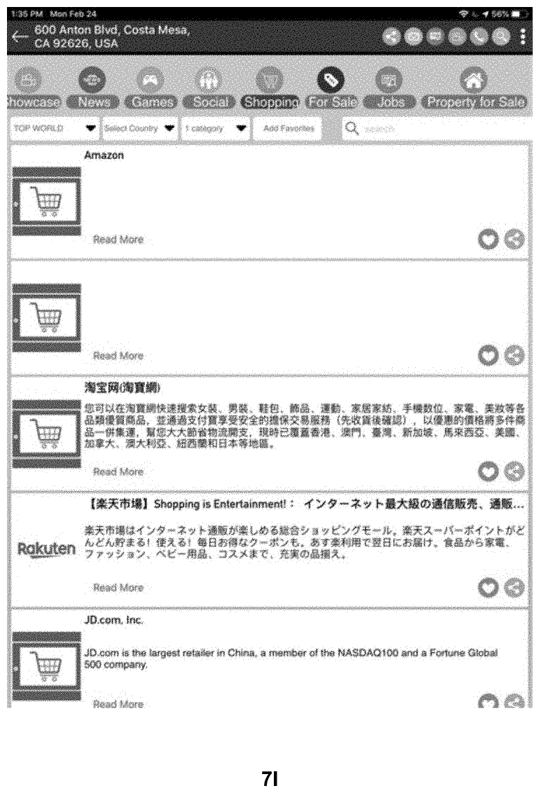

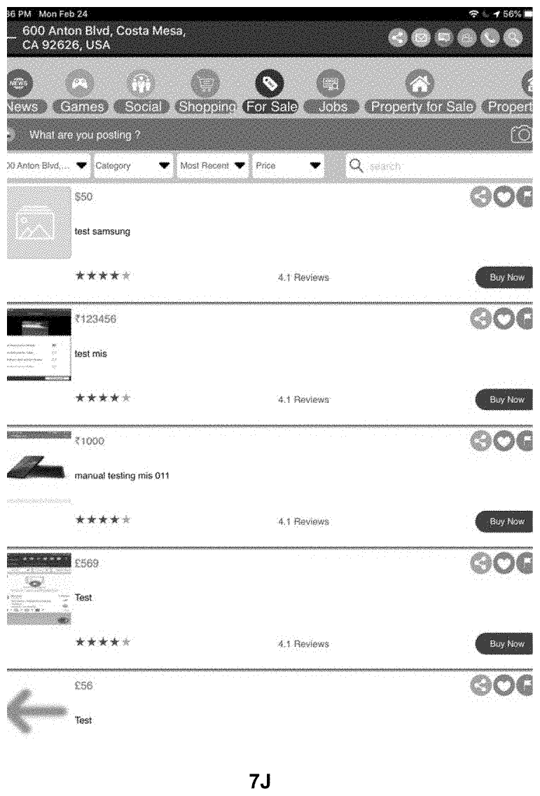

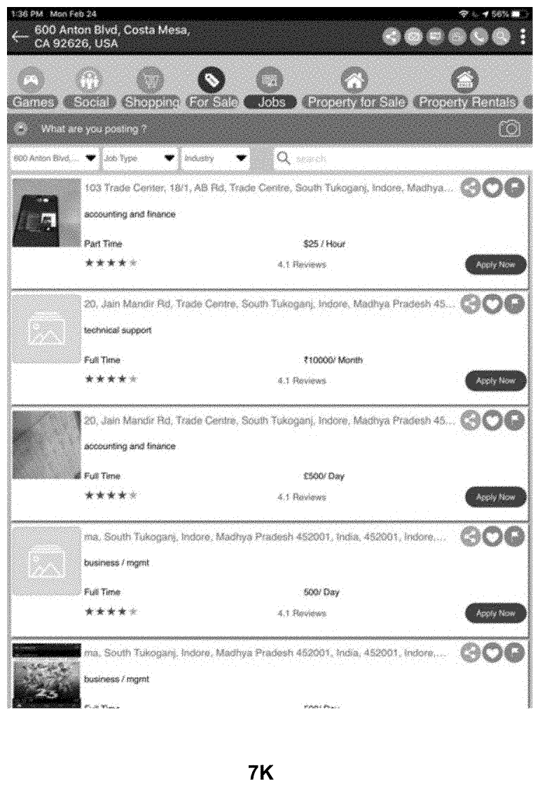

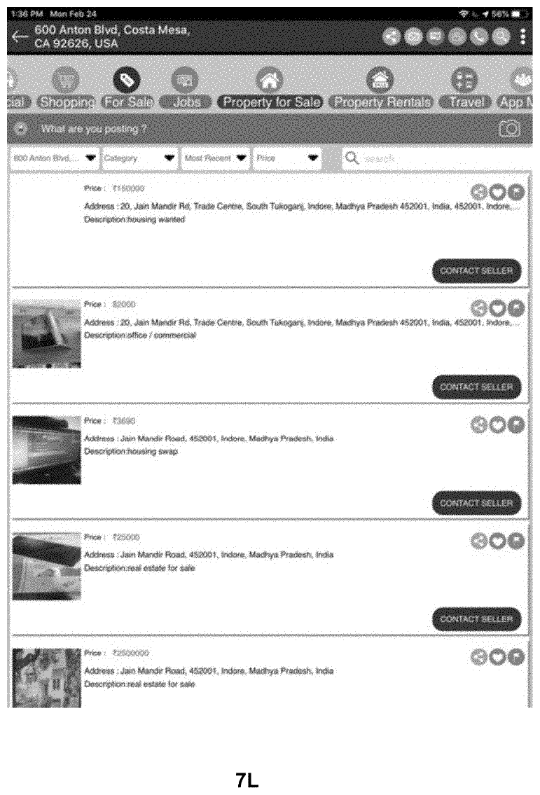

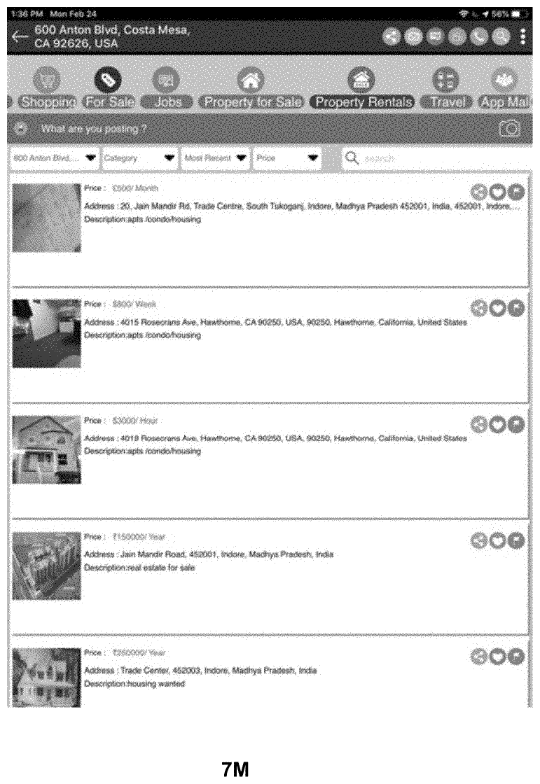

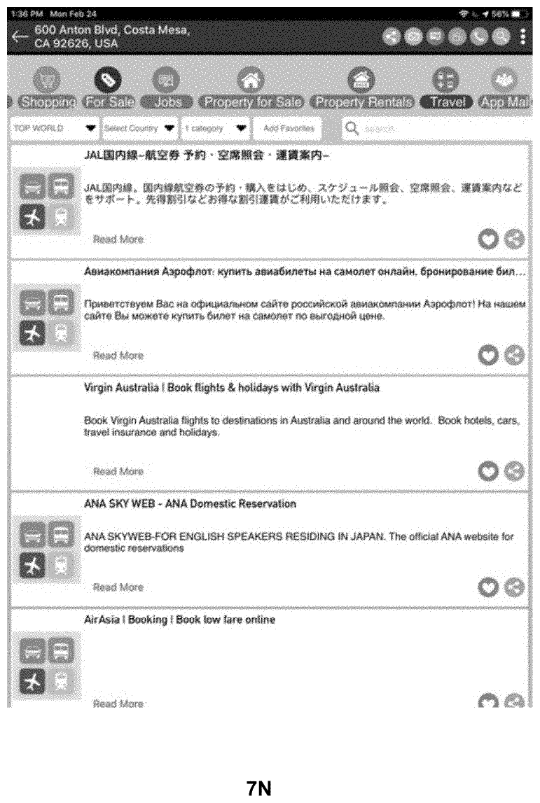

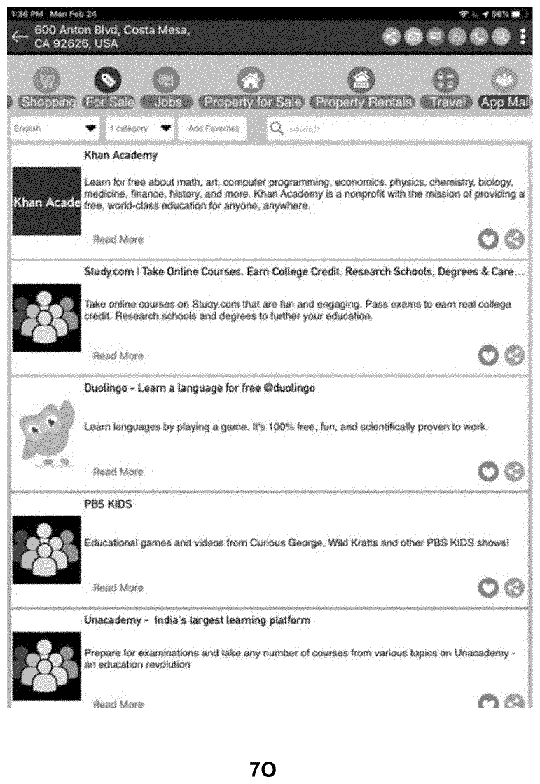

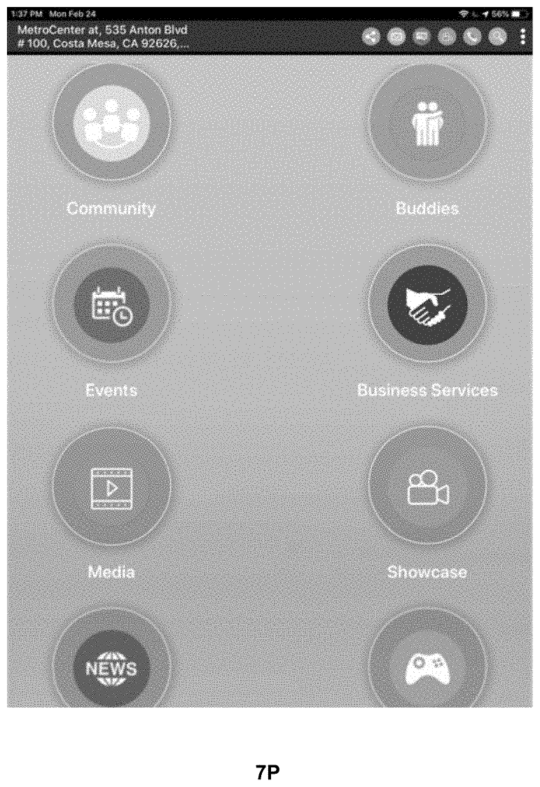

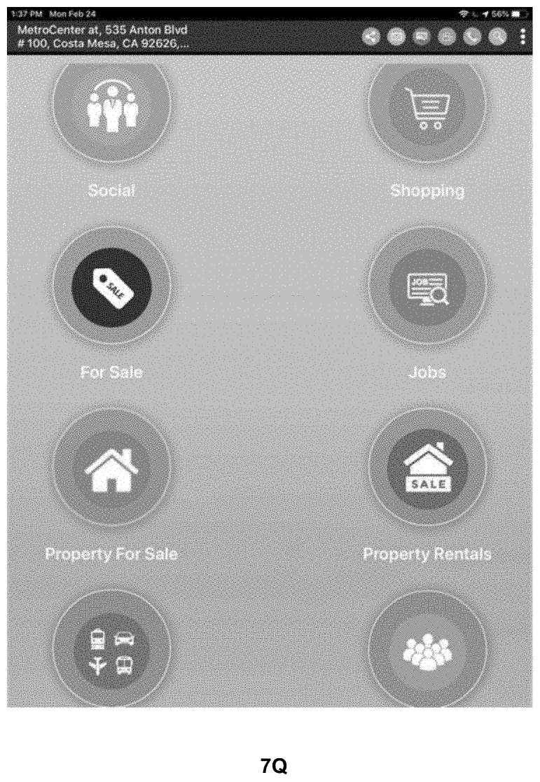

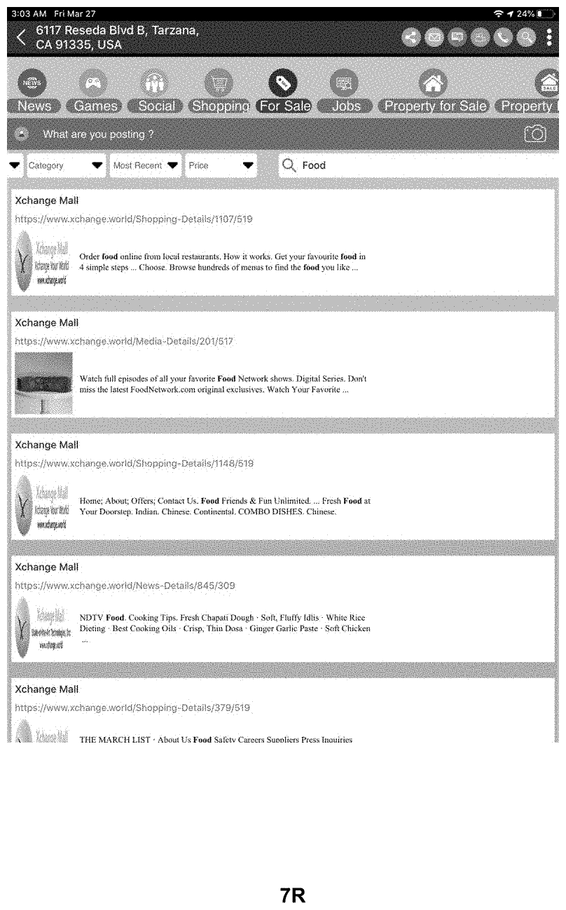

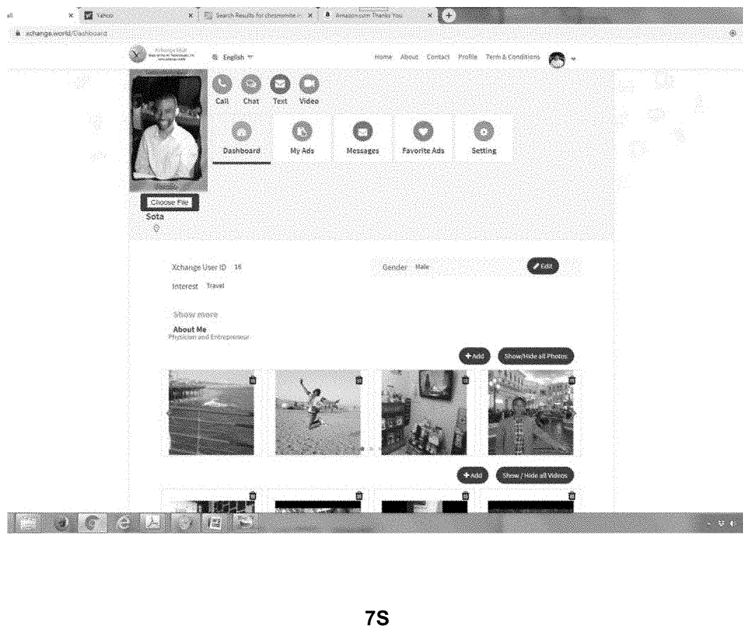

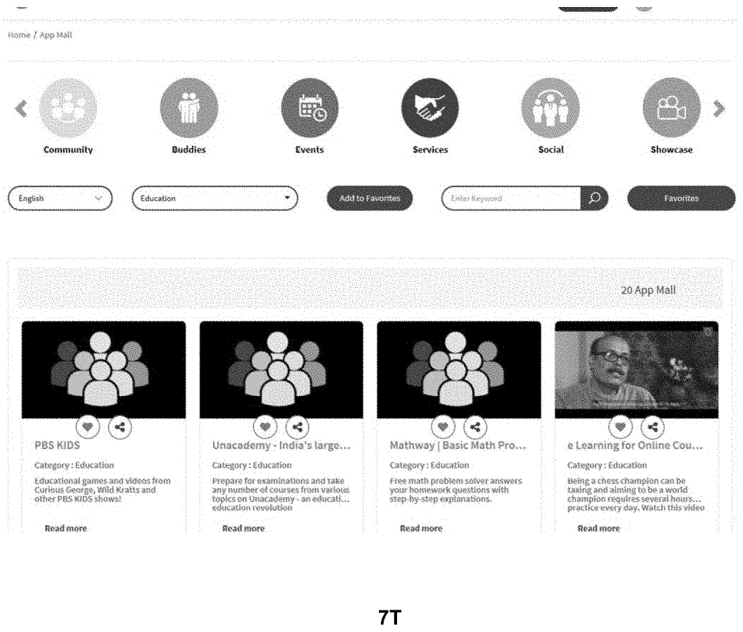

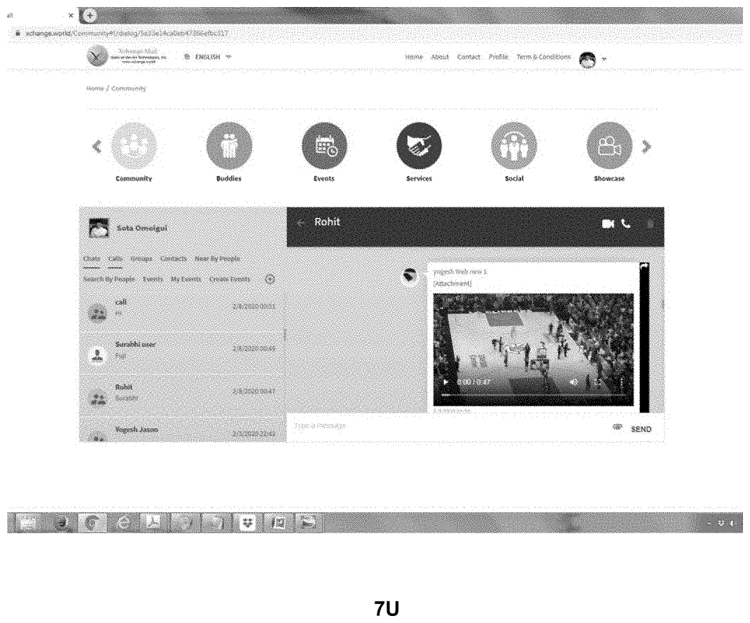

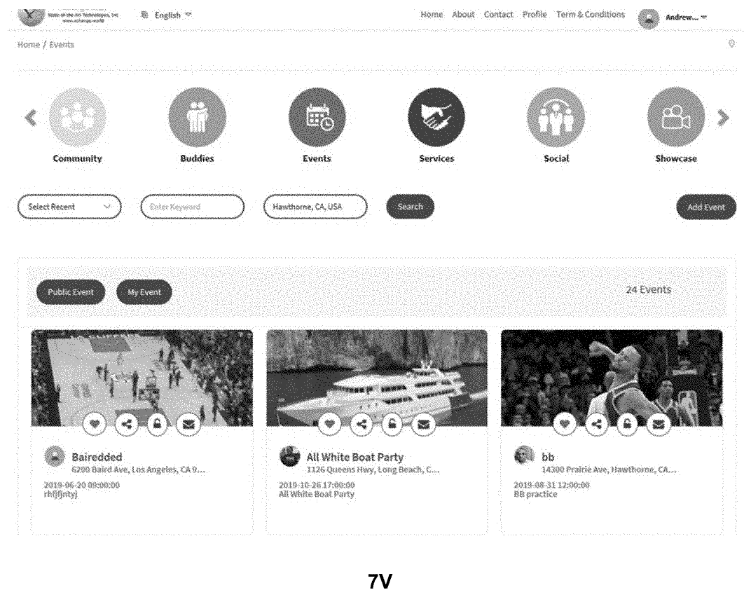

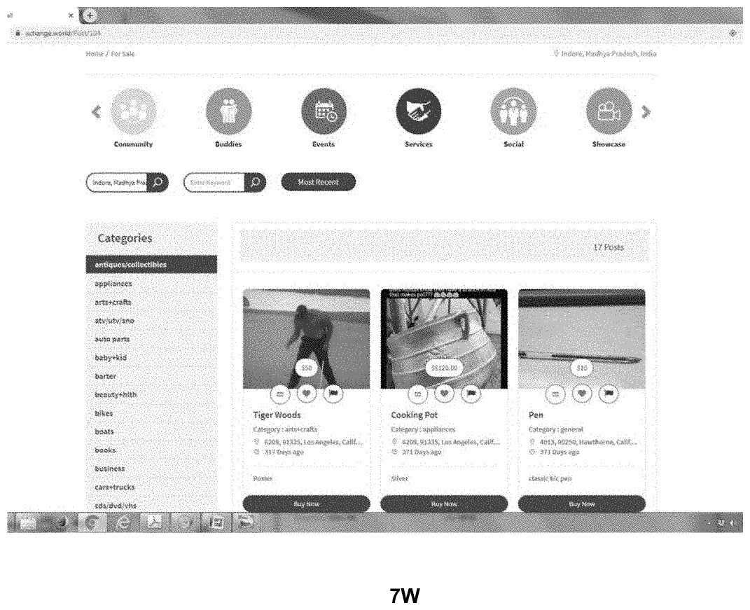

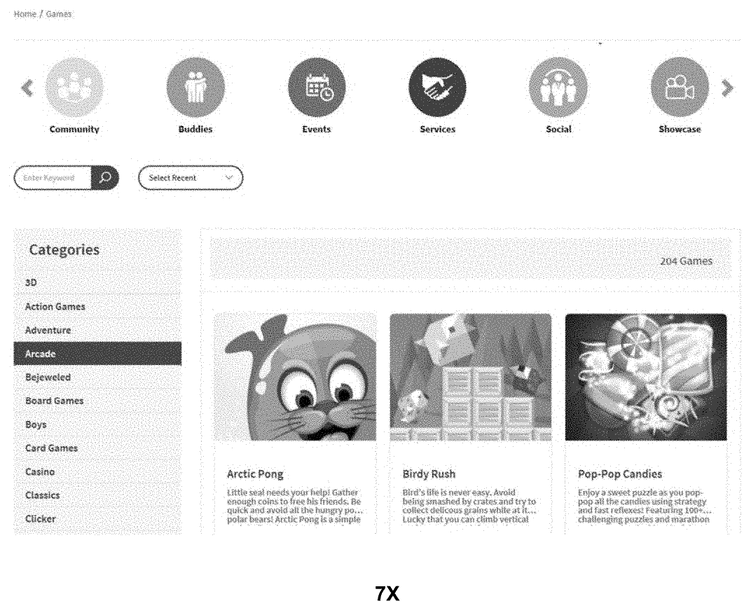

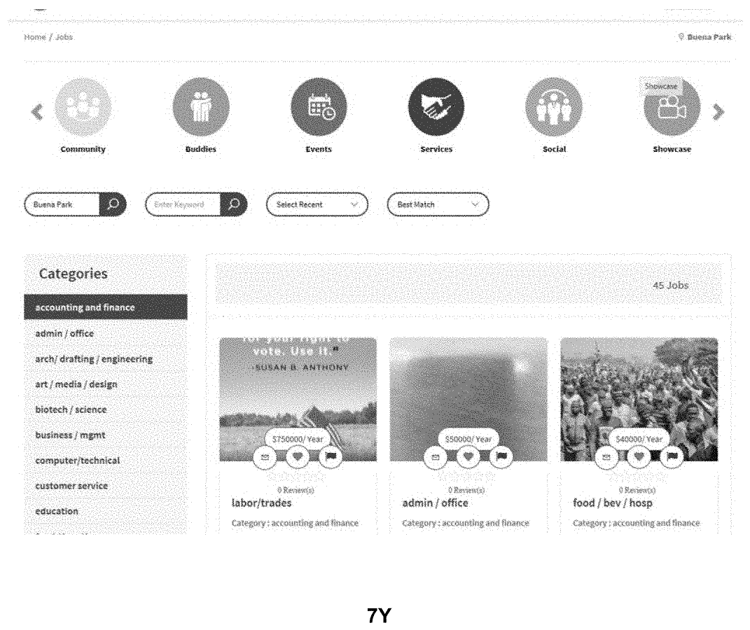

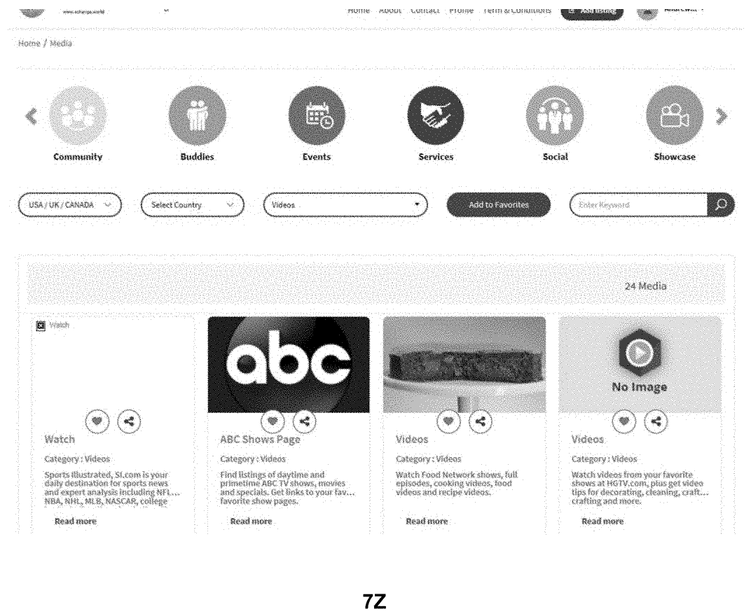

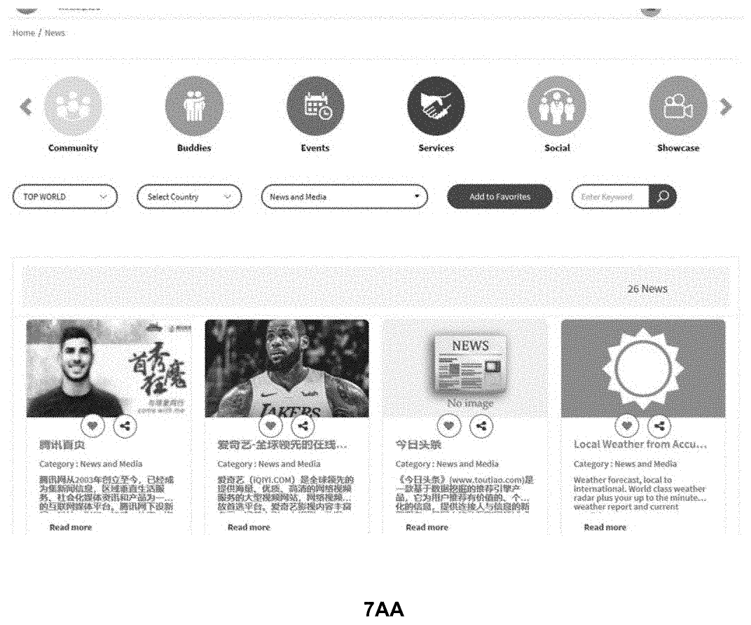

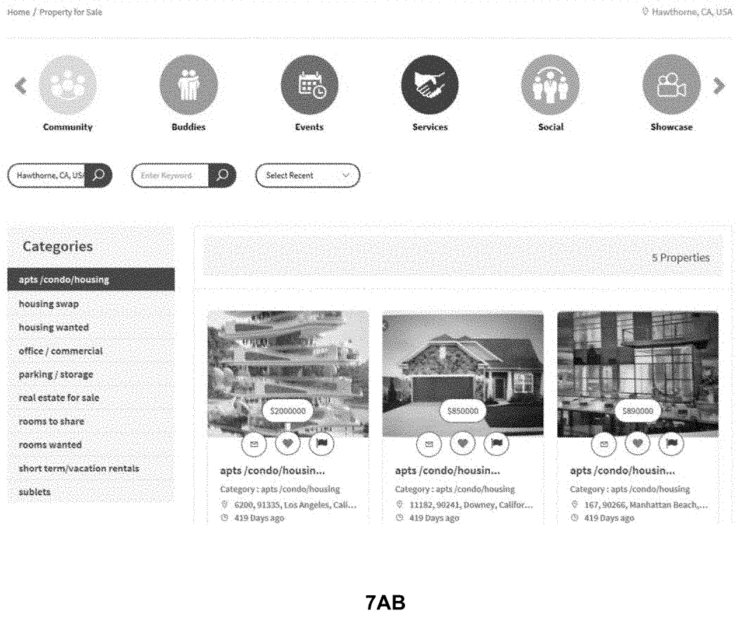

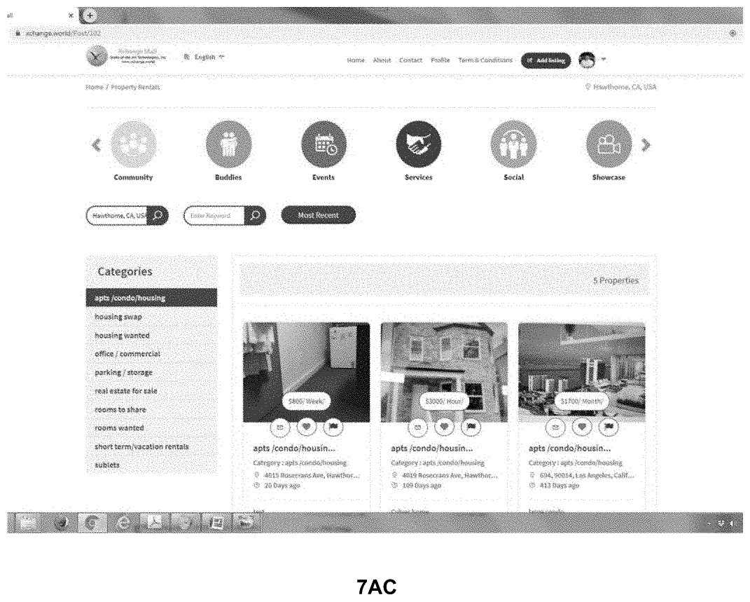

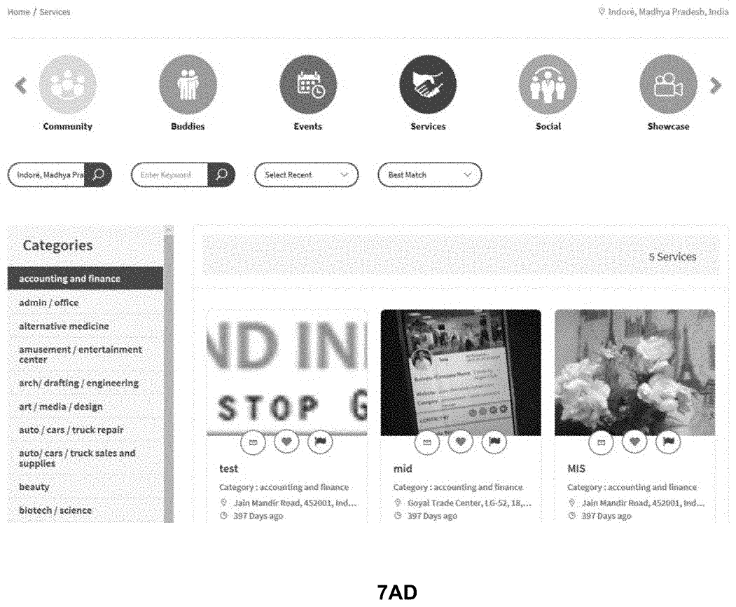

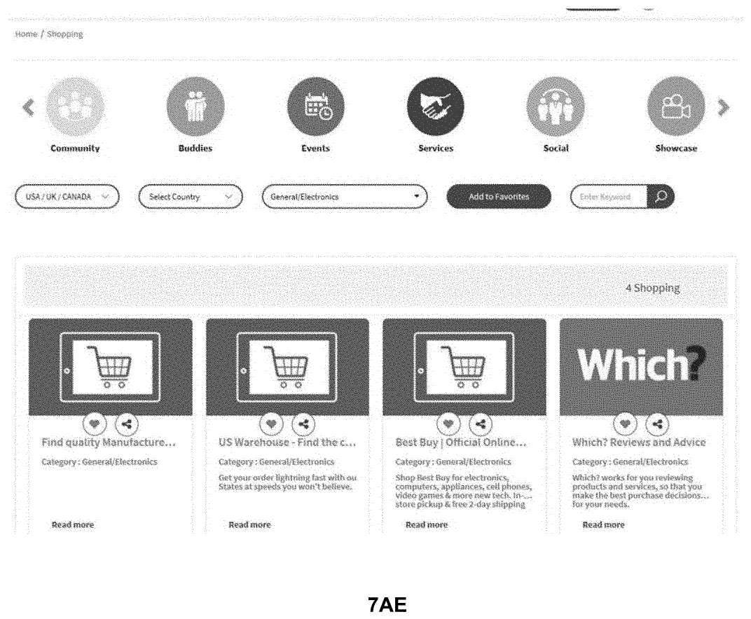

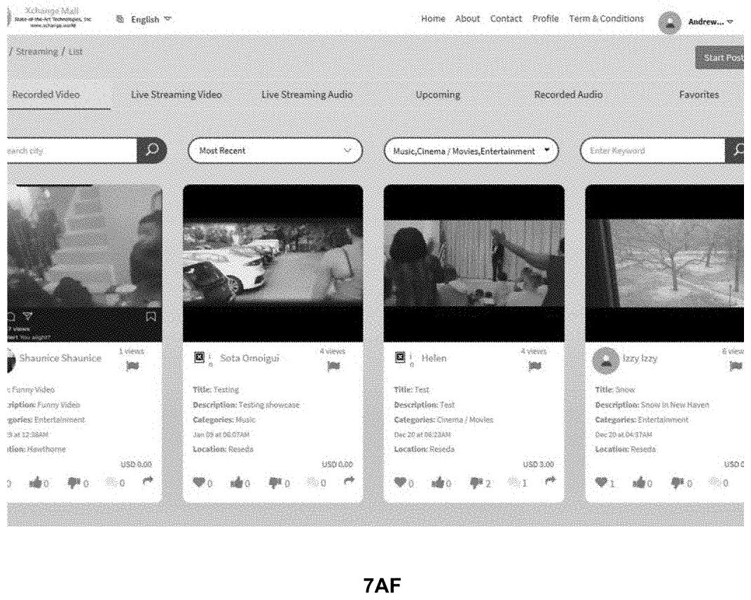

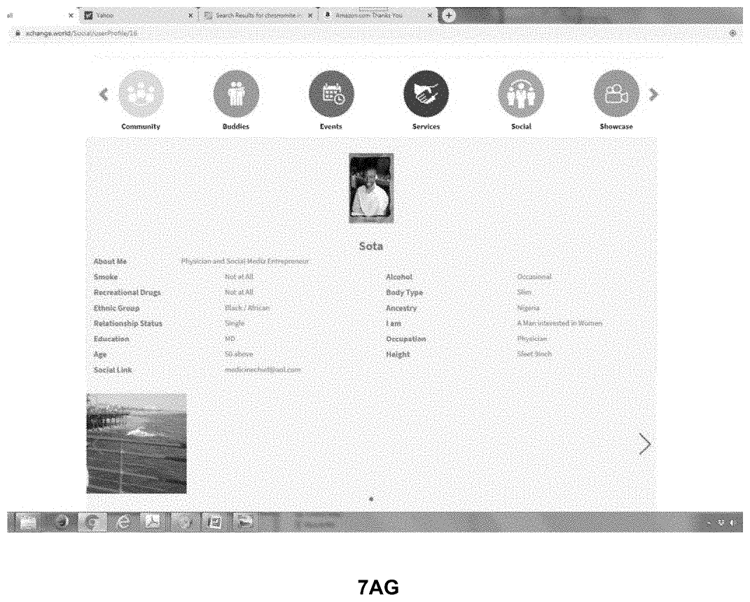

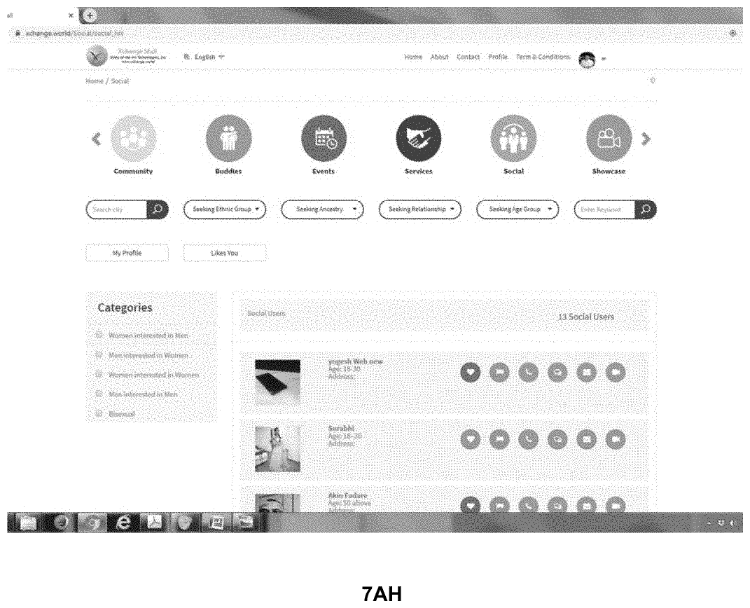

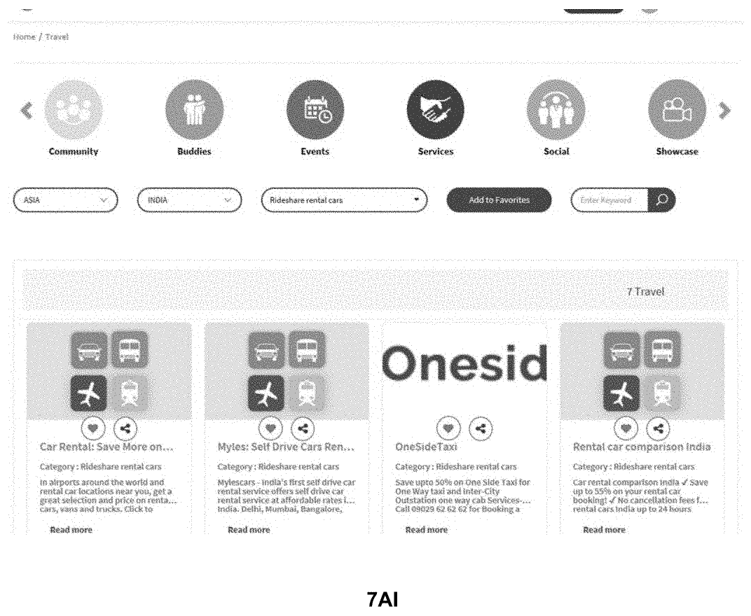

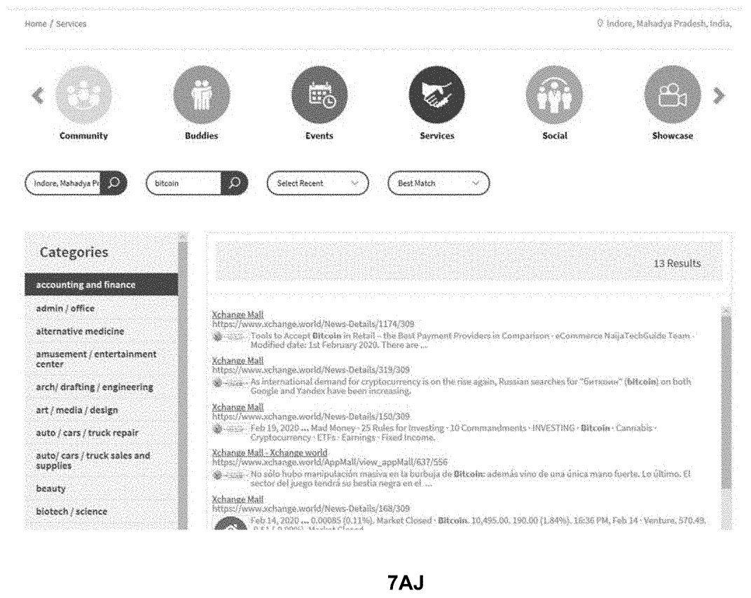

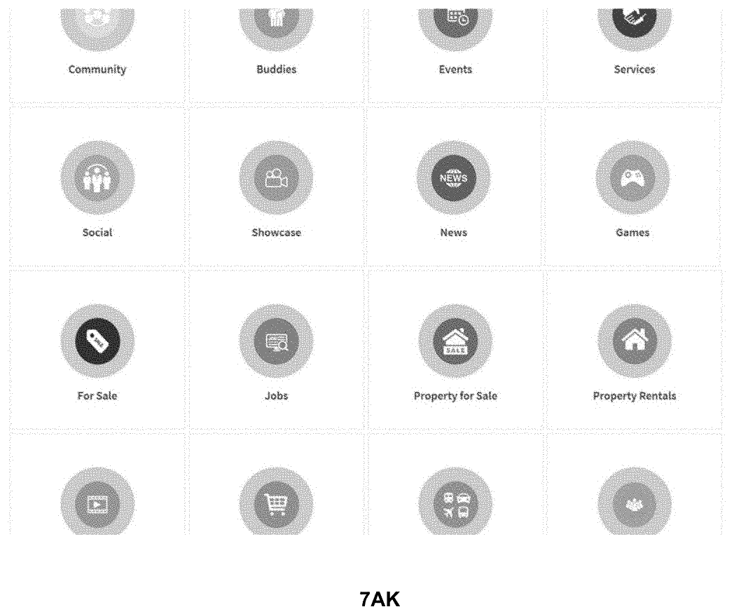

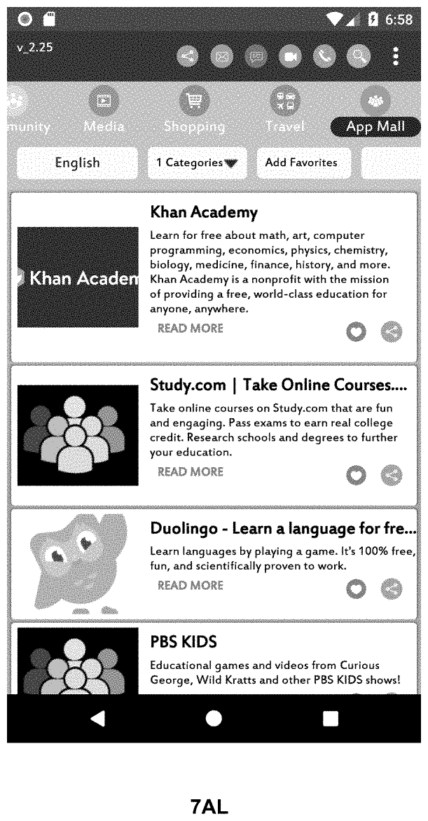

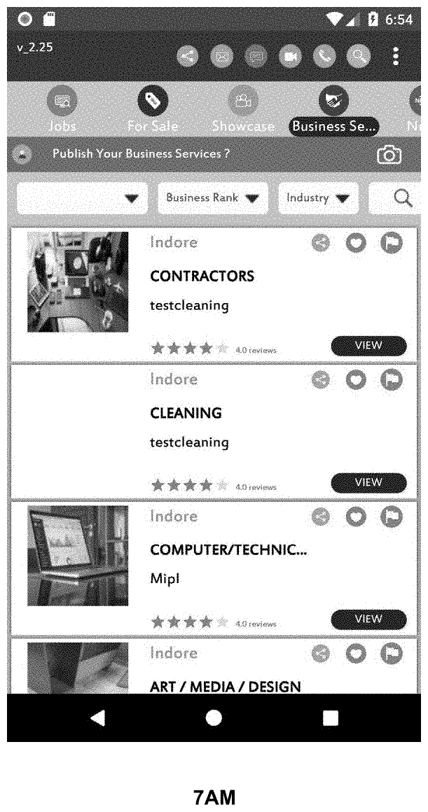

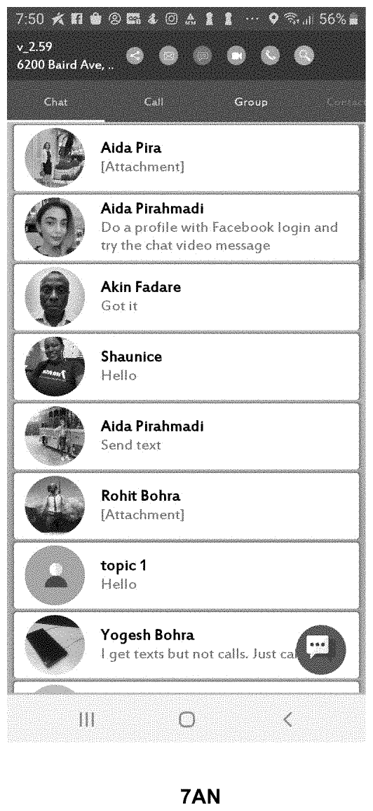

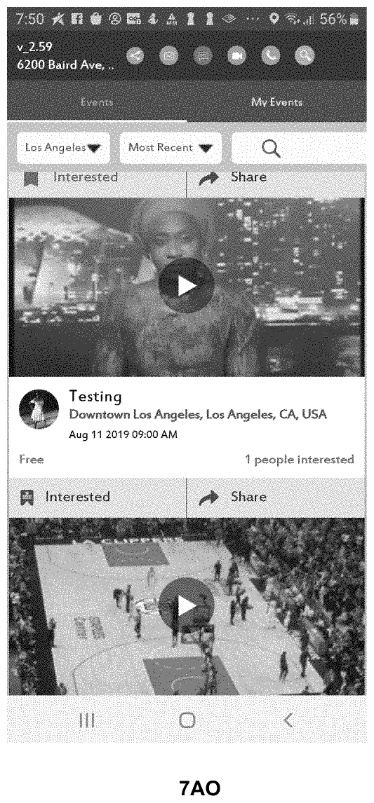

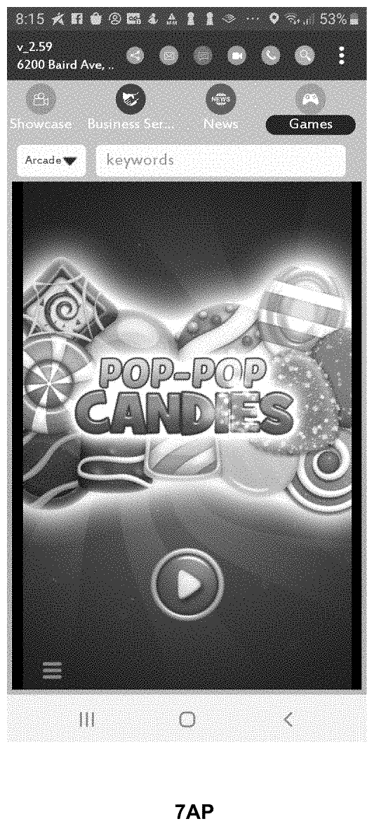

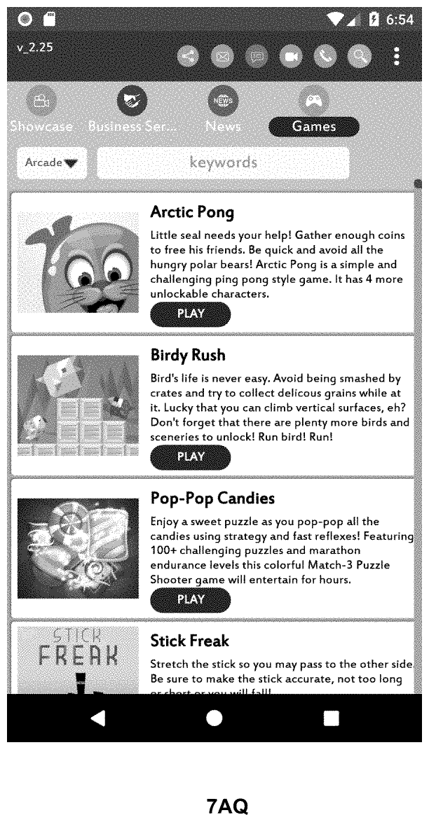

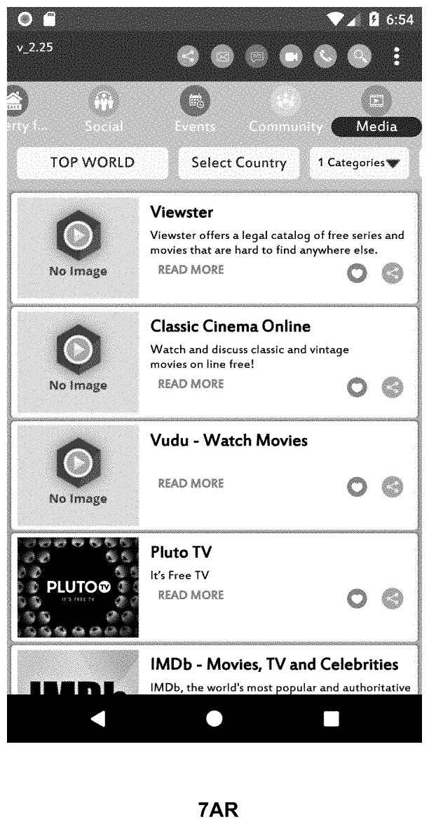

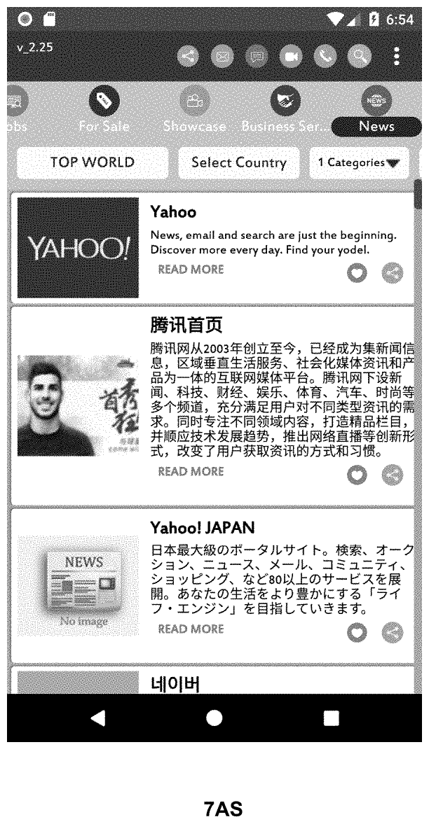

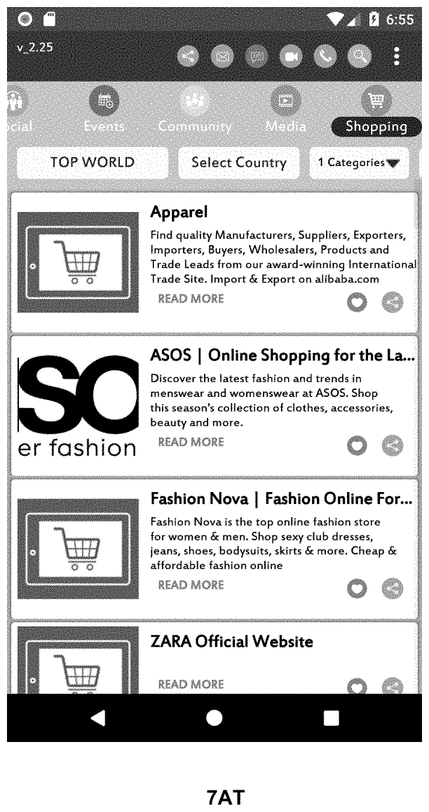

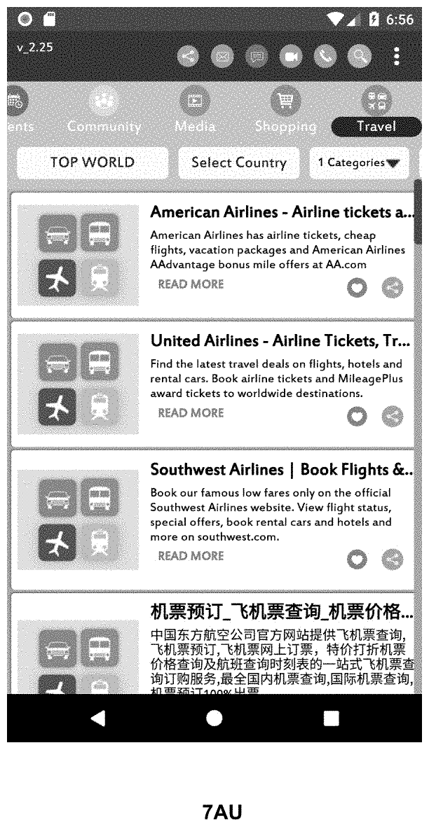

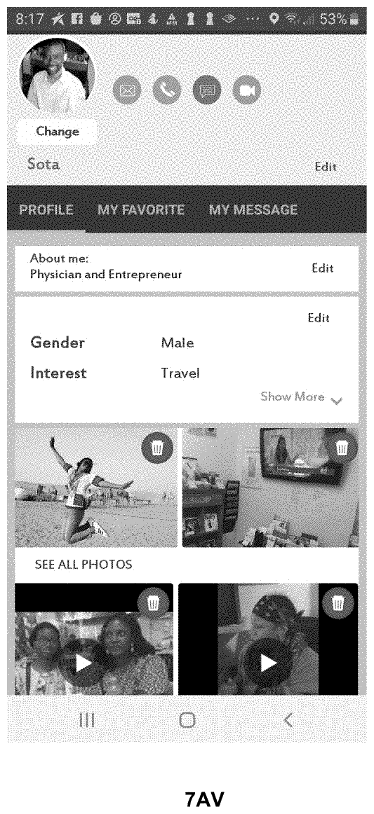

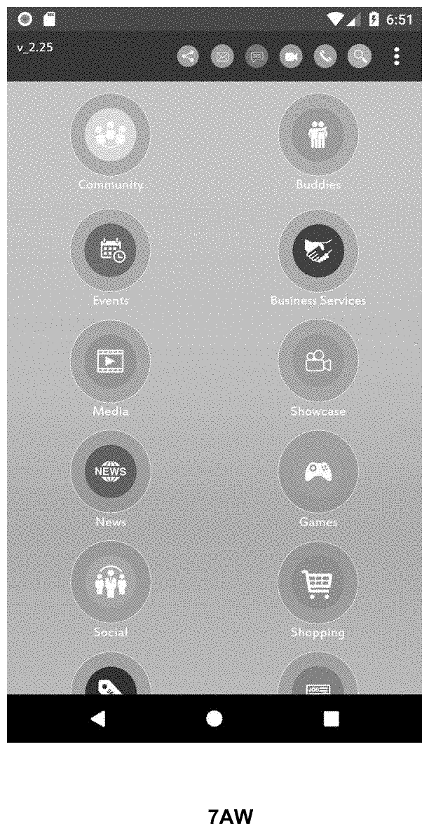

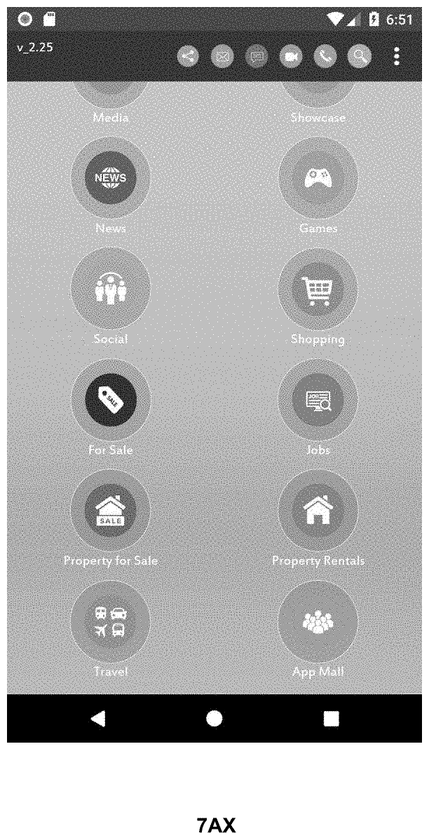

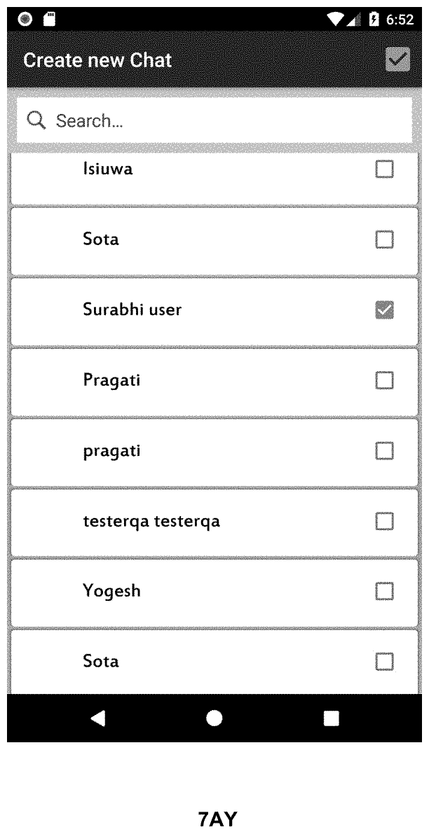

FIG. 6 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 600 in a manner as follows.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons, image, or links, and/or moving one or more images, etc., and sends a corresponding signal to bus 602. I/O component 604 may also include an output component, such as a display 611 and a cursor control 613 (such as a keyboard, keypad, mouse, etc.). An optional audio input/output component 605 may also be included to allow a user to use voice for inputting information by converting audio signals. Audio I/O component 605 may allow the user to hear audio. A transceiver or network interface 606 transmits and receives signals between computer system 600 and other devices, such as another communication device, service device, or a service provider server via network 140. In one embodiment, the transmission is wireless, although other transmission mediums and methods may also be suitable. One or more processors 612, which can be a micro-controller, digital signal processor (DSP), or other processing component, processes these various signals, such as for display on computer system 600 or transmission to other devices via a communication link 618. Processor(s) 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor(s) 612 and other components by executing one or more sequences of instructions contained in system memory component 614. Logic may be encoded in a computer readable medium, which may refer to any medium that participates in providing instructions to processor(s) 612 for execution. Such a medium may take many forms, including but not limited to, non-volatile media, volatile media, and transmission media. In various embodiments, non-volatile media includes optical or magnetic disks, volatile media includes dynamic memory, such as system memory component 614, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

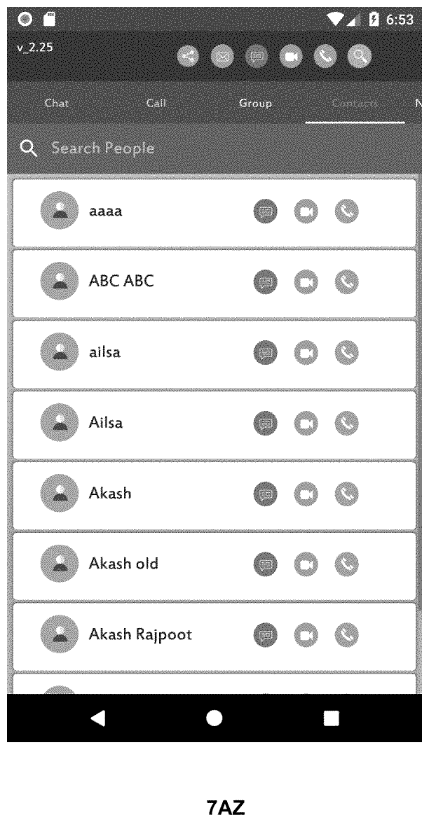

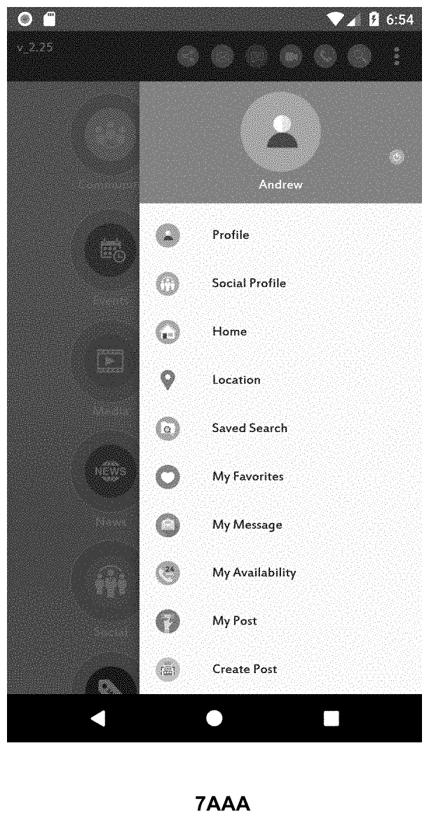

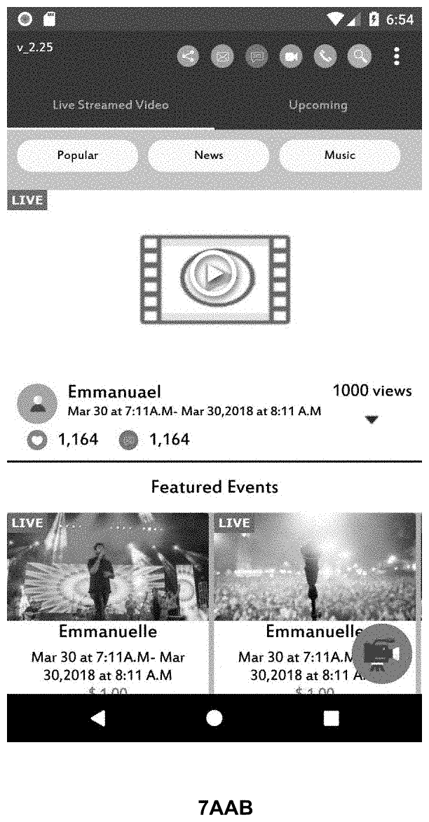

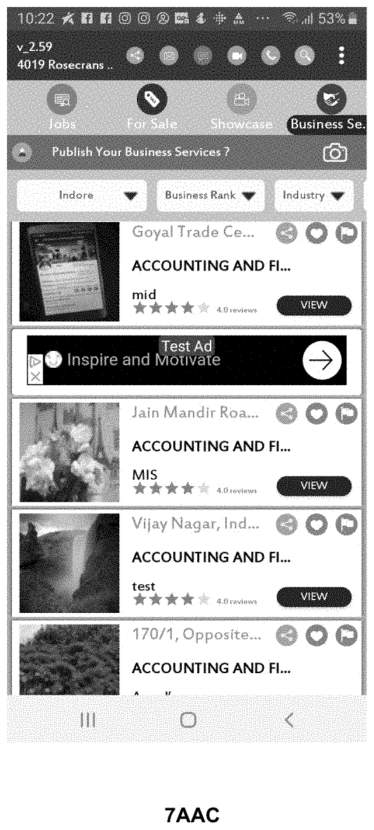

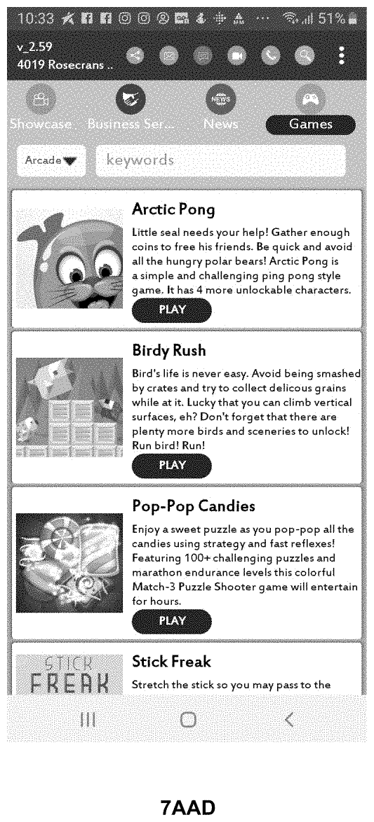

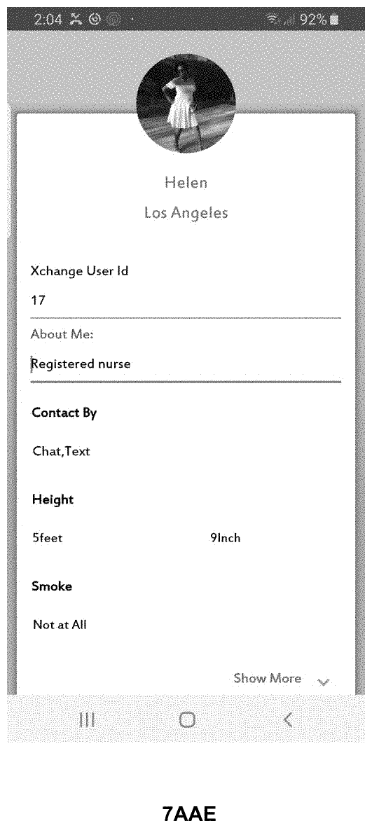

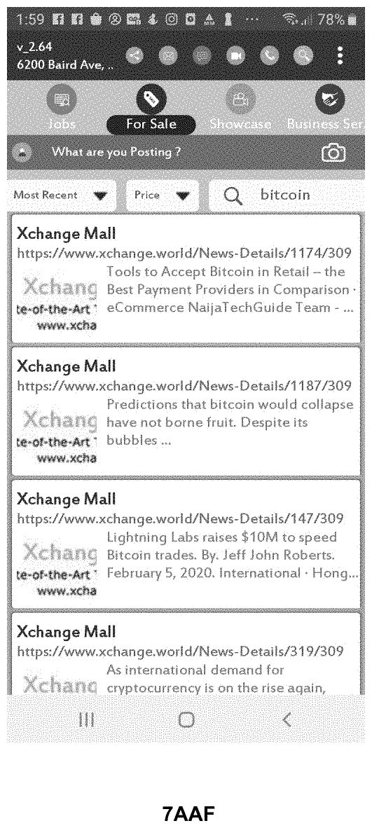

FIG. 7A-7AAF are exemplary screenshots of a super application as presented on different device platforms, according to embodiments. In particular, FIGS. 7A-7AAF show how the super application may be presented on different device platforms as discussed herein, where the different device platforms that may present the super application may include a website (e.g., accessible through a web browser), an iOS® operating system, an Android® operating system, and the like. FIGS. 7A-7R show the super application on an iOS® platform, such as one presented on a mobile phone, a tablet computer, or a desktop computer running such an operating system. FIGS. 7S-7AK show the super application on a website. FIGS. 7AL-7AAF show the super application on an Android® platform, such as one presented on a mobile phone, a tablet computer, or a desktop computer running such an operating system.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A data aggregation system of a service provider, the data aggregation system comprising:
a non-transitory memory; and
one or more hardware processors coupled to the non-transitory memory and configured to read instructions from the non-transitory memory to cause the data aggregation system to perform operations comprising:
receiving, from a client device, a data population request in a first data channel provided by the service provider, wherein the first data channel comprises a first data channel interface displayable by the client device;
determining a corpus of online resources selected for the data aggregation system associated with the first data channel, wherein the corpus of online resources comprise a first plurality of websites culled by a data aggregation process of the data aggregation system for the first data channel;
retrieving first website data from the first plurality of websites associated with the first data channel, wherein the first website data is retrieved in real-time based on the first plurality of web sites; and
delivering the first website data to the client device without requiring navigation by the client device to the first plurality of websites, wherein the first website data is embedded in a first plurality of interface elements of the first data channel interface corresponding to the first plurality of websites.

2. The data aggregation system of claim 1, wherein prior to receiving the data population request, the operations further comprise:
detecting the client device at a channel selection interface provided by the service provider; and
receiving a navigation request to the first data channel from the channel selection interface.

3. The data aggregation system of claim 1, wherein the operations further comprise:
receiving a selection of one of the first plurality of interface elements; and
delivering additional website data associated with one of the first plurality of websites corresponding to the one of the first plurality of interface elements within the first data channel interface without navigation of the client device to the one of the first plurality of websites.

4. The data aggregation system of claim 1, wherein the data population request is received via a dedicated application resident on the client device comprising a mobile device of a user, and wherein the delivering the first website data is through application layout objects of the dedicated resident application that correspond to the first plurality of interface elements.

5. The data aggregation system of claim 4, wherein the application layout objects comprise one of WebView objects, WKWebView objects, and/or UIWEBView, and wherein the application layout objects are dependent on an operating system of the client device.

6. The data aggregation system of claim 1, wherein the data population request is received via a website hosted by the service provider, wherein the delivering the first website data is through website layout elements of a webpage of the website that correspond to the first plurality of interface elements.

7. The data aggregation system of claim 6, wherein the website layout elements comprise inline frames embedded within a hypertext markup language (HTML) document corresponding to the webpage.

8. The data aggregation system of claim 1, wherein the operations further comprise:
providing a plurality of menu options within the first data channel, wherein the plurality of menu options are configured to provide a search process for the first web site data within the first data channel.

9. The data aggregation system of claim 8, wherein prior to determining the first web site data, the operations further comprise:
receiving a search query from the client device based on the plurality of menu options.
executing a search of the data aggregation system for identification of websites corresponding to the search query; and
determining the first plurality of websites based on the search.

10. The data aggregation system of claim 1, wherein the first data channel comprises one of a plurality of data channels, wherein each of the plurality of data channels provide a separate application functionality offered by the service provider to the client device, and wherein the operations comprise:
providing at least one of a home screen channel selection interface for the plurality of data channels or a channel selection toolbar in the plurality of data channels through one of a website of the service provider or a dedicated application of the service provider.

11. The data aggregation system of claim 10, wherein the one of the website or the dedicated application comprise a super application that streams the first website data and additional web site data for the plurality of data channels within the super application without requiring external navigation to another resource by the client device.

12. The data aggregation system of claim 1, wherein prior to retrieving the first web site data, the operations further comprise:
determining a subset of the plurality of first websites based on preferences associated with the client device, wherein the first website data is for the subset of the plurality of first web sites; and
determining a display order of the first website data in the first plurality of interface elements based on the preferences,
wherein the first website data is delivered based on the display order in the first plurality of interface elements.

13. The data aggregation system of claim 1, wherein the operations further comprise:
receiving a navigation request to a second data channel provided by the service provider, wherein the corpus of online resources comprise a second plurality of websites culled by the data aggregation process of the data aggregation system for the second data channel;
navigating the client device to the second data channel;
retrieving second website data from the second plurality of websites associated with the second data channel, wherein the second website data is retrieved in real-time based on the second plurality of websites; and
delivering the second website data to the client device without requiring navigation by the client device to the second plurality of websites, wherein the second website data is embedded in a second plurality of interface elements of the second data channel corresponding to the second plurality of websites.

14. A method comprising:
receiving, by an online content aggregator of a service provider, a designation of online resources for a plurality of data aggregation channels of the service provider, wherein each of the plurality of data aggregation channels comprise an online portal having an interface for output of one or more of the online resources;
detecting a navigation by a client device to one of the plurality of data aggregation channels from a channel selection interface of the service provider;
determining at least one of the online resources for the one of the plurality of data aggregation channels based on the designation of the online resources; and
streaming online data for the at least one of the online resources within at least one embedded element for the interface of the one of the plurality of data aggregation channels.

15. The method of claim 14, further comprising:
receiving a selection request of one of the at least one embedded element; and
populating additional online data for a corresponding one of the at least one of the online resources within the interface.

16. The method of claim 14, wherein receiving the designation of the online resources comprises:
generating a relational database management system (RDBMS) based on the online resources culled by a data aggregation process of the online content aggregator, wherein the RDBMS is searched for the at least one of the online resources.

17. The method of claim 16, wherein prior to determining the at least one of the online resources, the method further comprises:
receiving a query from the client device for the at least one of the online resources within the one of the plurality of data aggregation channels;
converting the query for the RDBMS; and
determining the at least one of the online resources using the converted query and the RDBMS.

18. A non-transitory machine-readable medium having stored thereon machine-readable instructions executable to cause a machine to perform operations comprising:
receiving, from a resident application on a device, an application navigation event to a channel portal of a service provider;
determining website data for the channel portal from a relational database management system (RDBMS) of the service provider, wherein the website data is determined using a database query in a query language for the RDBMS;
determining a display preference for the website data specific to the device for the channel portal; and
displaying the website data within an interface of the channel portal based on di splay the di splay preference.

19. The non-transitory machine-readable medium of claim 18, wherein the operations further comprise:
receiving a request to execute a communication over an online communication platform from the resident application; and
executing the communication through the resident application from the channel portal using the online communication platform.

20. The non-transitory machine-readable medium of claim 18, wherein the operations further comprise:
receiving a request to post content within the channel portal from the resident application;
storing the content to the RDBMS based on the query language; and
providing the content within the channel portal to at least one additional device.
